(19) United States
(12) Patent Application Publication
(10) Pub. No.: US 2014/0114047 A1
(43) Pub. Date: Apr. 24, 2014

(54) HYBRID EPOXY RESINS

(71) Applicant: DOW GLOBAL TECHNOLOGIES LLC, Midland, MI (US)

(72) Inventor: Robert E. Hefner, JR., Rosharon, TX (US)

(73) Assignee: DOW GLOBAL TECHNOLOGIES LLC, Midland, MI (US)

(21) Appl. No.: 14/119,618

(22) PCT Filed: Jun. 14, 2012
(86) PCT No.: PCT/US2012/042341

§ 371 Date: Nov. 22, 2013

Related U.S. Application Data
(60) Provisional application No. 61/503,867, filed on Jul. 1, 2011.

(51) Int. Cl. C08G 59/04

(52) U.S. Cl. CPC C08G 59/04
USPC 528/418

(57) ABSTRACT

A hybrid polyfunctional aliphatic and/or cycloaliphatic epoxy (H-PACE) resin composition comprising, consisting of or consisting essentially of: (a) a moiety selected from the group consisting of an aliphatic moiety, a cycloaliphatic moiety, and combinations thereof provided by the polyfunctional aliphatic and/or cycloaliphatic epoxy (PACE) resin; and (b) a moiety selected from the group consisting of an aliphatic moiety, a cycloaliphatic moiety, and combinations thereof, wherein said moiety is not provided by the PACE resin, is disclosed. Processes for making and using such resin composition are also disclosed.

### REFERENCE TO RELATED APPLICATIONS

This application is a non-provisional application claiming priority from the U.S. Provisional Patent Application No. 61/503,867, filed on Jul. 1, 2011, entitled “HYBRID EPOXY RESINS” the teachings of which are incorporated by reference herein, as if reproduced in full hereinbelow.

### BACKGROUND OF THE INVENTION

1. Field of the Invention

The present invention is related to polyfunctional aliphatic and/or cycloaliphatic epoxy resin compositions.

2. Description of Background and Related Art

Resin products can be used for can coatings. These products may be based on an advancement reaction of a diphenol and a high purity diglycidyl ether (DGE) of an aliphatic and /or cycloaliphatic epoxy resin. A fractionation process can be used to produce high purity DGE. This process inherently co-produces thermosettable compositions based on the oligomers polyfunctional aliphatic cycloaliphatic epoxy (PACE) resin. There are also thermosettable compositions based on the re-epoxidatized oligomers [re-epoxidized polyfunctional aliphatic cycloaliphatic epoxy (PACE) resin]. The PACE resin and re-epoxidized PACE resin technologies provide highly useful epoxy resins, however, there is substantial room for improvement in the properties of said resins. The process of the present invention provides hybrid PACE (H-PACE) resins containing chemical structures that were heretofore unattainable. Through the process of the present invention, the composition and relative amount of the chemical structures may be adjusted to enhance specific physical or mechanical properties of the H-PACE resin and thermoset compositions prepared from said H-PACE resins relative to those provided by the PACE resin.

The process of the present invention further provides a viable outlet for an aliphatic and/or cycloaliphatic MGE, DGE, or MGE and DGE stream that otherwise might be unused thus deleteriously impacting the economics of an epoxy resin product. The aliphatic and/or cycloaliphatic MGE, DGE, or MGE and DGE stream may conveniently be used as a co-reactant in a new epoxidation of a different aliphatic and/or cycloaliphatic hydroxyl-containing reactant to produce an H-PACE resin composition of the present invention. Thus, addition of an aliphatic MGE, DGE, or MGE and DGE stream as a reactant in the epoxidation of a cycloaliphatic or cycloaliphatic and aliphatic hydroxyl-containing reactant increases the amount of aliphatic structure in the resultant H-PACE resin. This in turn may increase toughness, moisture resistance, flexibility, impact resistance and the like in thermosets prepared from said H-PACE resin. Likewise, co-reaction of a cycloaliphatic or cycloaliphatic and aliphatic hydroxyl-containing reactant increases the amount of cycloaliphatic structure in the resultant H-PACE resin. Increases in glass transition temperature, abrasion resistance, flexural modulus and the like may result in thermosets prepared from said H-PACE resin. Reaction of an aliphatic and/or cycloaliphatic MGE, DGE, or MGE and DGE in an epoxidation of a cycloaliphatic or cycloaliphatic and aliphatic hydroxyl-containing reactant may additionally be employed to modify viscosity of the resultant H-PACE resin, to improve compatibility of the resultant H-PACE resin with various curing agents and/or curing catalysts, to improve compatibility of the resultant H-PACE resin with one or more other epoxy resins which may be used to prepare blends, and/or to improve compatibility of the resultant H-PACE resin blend with one or more other epoxy resins and various curing agents.

To increase the functionality of an aliphatic and/or cycloaliphatic epoxy resin, the MGE product inherently co-produced in the epoxidation of the aliphatic and/or cycloaliphatic hydroxyl-containing reactant may be removed, for example by distillation, to leave behind the DGE and oligomers substantially free of the monofunctional MGE. The recovered MGE may conveniently be used as a co-reactant in a new epoxidation of a different aliphatic and/or cycloaliphatic hydroxyl-containing reactant to produce an H-PACE resin. This use of the otherwise unused MGE can favorably impact the economics and performance of the epoxy resin products.

Furthermore the process of the present invention can produce the novel H-PACE resin compositions while simultaneously providing high purity aliphatic/cycloaliphatic diglycidyl ether currently used in (1) advancement chemistry to provide can coating resins or used directly without advancement for example as a (2) reactive epoxy resin diluent.

### SUMMARY OF THE INVENTION

In an embodiment of the invention, there is disclosed a hybrid polyfunctional aliphatic and/or cycloaliphatic epoxy (H-PACE) resin composition comprising, consisting of, or consisting essentially of:
(a) a moiety selected from the group consisting of an aliphatic moiety, a cycloaliphatic moiety, and combinations thereof provided by the polyfunctional aliphatic and/or cycloaliphatic epoxy (PACE) resin; and
(b) a moiety selected from the group consisting of an aliphatic moiety, a cycloaliphatic moiety, and combinations thereof, wherein said moiety is not provided by the PACE resin.

In another embodiment of the invention, there is disclosed a H-PACE resin composition comprising, consisting of, or consisting essentially of a reaction product of:
(a) a hydroxyl-containing material selected from the group consisting of an aliphatic hydroxyl-containing material, a cycloaliphatic hydroxyl-containing material, and combinations thereof;
(b) a material selected from the group consisting of a monoglycidyl ether containing material, a diglycidyl ether containing material, and combinations thereof;
(c) an epihalohydrin;
(d) a basic acting substance;
(e) a non-Lewis acid catalyst; and
(f) optionally, a solvent,
   wherein (b) is prepared from a different precursor than (a).

### DETAILED DESCRIPTION OF THE INVENTION

In an embodiment of the invention, there is provided a hybrid polyfunctional aliphatic and/or cycloaliphatic epoxy (H-PACE) resin composition comprising, consisting of, or consisting essentially of:
(a) an aliphatic and/or cycloaliphatic moiety provided by the polyfunctional aliphatic and/or cycloaliphatic epoxy (PACE) resin which additionally contains
(b) an aliphatic and/or cycloaliphatic moiety that is different from that provided by the PACE resin.

The H-PACE resin includes (a) an aliphatic and/or cycloaliphatic moiety provided by the PACE resin which additionally contains (b) an aliphatic and/or cycloaliphatic moiety that is different from that provided by the PACE resin. Producing the H-PACE resin involves selection of a stream of a material selected from the group consisting of monoglycidyl ether (MGE), diglycidyl ether (DGE), and combinations thereof (collectively hereinafter referred to as ‘glycidyl ether’), and a reactant that is of a different chemical structure than the aliphatic and/or cycloaliphatic hydroxyl-containing reactant being epoxidized. The resultant stream of glycidyl ether then serves as a reactant in the epoxidation of an aliphatic and/or cycloaliphatic hydroxyl-containing material that is of a different chemical structure.

Concerning the aliphatic and/or cycloaliphatic glycidyl ether stream used herein, MGE means a partially epoxidized aliphatic or cycloaliphatic hydroxyl-containing material while DGE denotes a fully epoxidized aliphatic or cycloaliphatic hydroxyl-containing material. When the aliphatic or cycloaliphatic hydroxyl-containing material is a diol, the MGE contains one unreacted hydroxyl group and one glycidyl ether group formed by epoxidation of a hydroxyl group. When the aliphatic or cycloaliphatic hydroxyl-containing material is a diol, the DGE contains two glycidyl ether groups formed by epoxidation of the two hydroxyl groups in the diol precursor. The aliphatic and/or cycloaliphatic glycidyl ether stream is a fraction which is co-produced during an epoxidation process for producing an aliphatic or cycloaliphatic epoxy resin product; wherein the co-produced glycidyl ether fraction and the aliphatic or cycloaliphatic epoxy resin product resultant mixture after the epoxidation process is subjected to a subsequent separation process such that the co-produced glycidyl ether fraction is substantially separated and isolated from the aliphatic or cycloaliphatic epoxy resin product. The separation process can be carried out by a known means such as, for example, a distillation unit operation. Once the co-produced glycidyl ether fraction is separated from the aliphatic or cycloaliphatic epoxy resin product, for example by distillation, the resulting separated/isolated glycidyl ether fraction, typically one or more cuts taken in a distillation process, comprises the glycidyl ether stream useful in the present invention. Thus, the partially epoxidized aliphatic or cycloaliphatic hydroxyl-containing material may contain 100% by weight MGE and 0% by weight DGE, to 100% by weight DGE and 0% by weight MGE. It follows that if the aliphatic or cycloaliphatic hydroxyl-containing material used was a triol, MGE, DGE, triglycidyl ether (TGE) or mixtures of two or more of the individual components may be used in the process of the present invention.

The glycidyl ether stream for use as a reactant may be obtained from any source capable of providing said reactant. For example, an epoxidation reaction and fractionation of the resultant epoxy resin may be specifically conducted to provide said glycidyl ether stream that is subsequently used in the epoxidation of an aliphatic and/or cycloaliphatic hydroxyl-containing material that is of a different chemical structure. As a second specific example, a commercially available aliphatic and/or cycloaliphatic epoxy resin may be fractionated to remove the desired glycidyl ether stream.

Specific epoxidation processes which may be employed in the present invention are delineated in EP 0 121 260 which provides examples of phase transfer catalyzed epoxidation of aliphatic diols, including cyclohexanedimethanol, using epichlorohydrin with quaternary ammonium halide catalysts. Specific epoxidation and fractionation processes which may be employed in the present invention are delineated in WO 2009/142901 which describes an epoxy resin composition prepared from a mixture of cis-, trans-1,3- and 1,4-cyclohexanedimethanols using several epoxidation processes and preparation of various purities of the distilled MGE and DGE of cis-, trans-1,3- and 1,4-cyclohexanedimethanol. Further specific epoxidation and fractionation processes which may be employed in the present invention are delineated in U.S. Patent Application Ser. No. 61/388,085. As is disclosed therein, the epoxidation may optionally be run partially or totally under vacuum in a manner that removes all or a part of the water, for example via azeotropic distillation. Said epoxidation process typically comprises the steps of (1) coupling of the epihalohydrin with the aliphatic or cycloaliphatic hydroxyl-containing material and (2) dehydrohalogenation of the intermediate halohydrin thus formed. The process may be, for example, a phase transfer catalyzed epoxidation process, a slurry epoxidation process, or an anhydrous epoxidation process. All of the aforementioned references are incorporated herein by reference.

Any aliphatic or cycloaliphatic hydroxyl-containing reactant may be employed in the epoxidation to produce the epoxy resin from which the glycidyl ether is recovered for use as a reactant in another epoxidation using a different aliphatic or cycloaliphatic hydroxyl-containing reactant. Likewise, any aliphatic or cycloaliphatic hydroxyl-containing reactant may be employed in the epoxidation to produce the H-PACE resin, as long as it is different than aliphatic or cycloaliphatic hydroxyl-containing reactant used to produce the glycidyl ether stream. Aliphatic and/or cycloaliphatic hydroxyl-containing materials which may be employed in the present invention may include for example any one or more of the following: (a) cyclohexanedialkanols and cyclohexenedialkanols such as UNOXOL™ Diol (cis-, trans-1,3- and 1,4-cyclohexanedimethanol) as a preferred cyclohexanedialkanol; (b) cyclohexanolmonoalkanols and cyclohexenolmonoalkanols, such as trans-2-(hydroxymethyl)cyclohexanol or 1-phenyl-cis-2-hydroxymethyl-r-1-cyclohexanol; (c) decahydronaphthalenedialkanols, octahydronaphthalenedialkanols and 1,2,3,4-tetrahydronaphthalenedialkanols, such as 1,2-decahydronaphthalenedimethanol; (d) bicyclohexanedialkanols or bicyclohexanolmonoalkanols, such as bicyclohexane-4,4′-dimethanol; (e) bridged cyclohexanols, such as hydrogenated bisphenol A (4,4′-isopropylidenediphenol); (f) other cycloaliphatic and polycycloaliphatic diols, monol monoalkanols, or dialkanols such as, cyclopentane-1,3-diol; or (g) aliphatic hydroxyl-containing materials such as aliphatic diols and alkoxylated phenolic reactants; as described in pages 9 to 15 of co-pending U.S. Patent Application Ser. No. 61/388,059, filed Sep. 30, 2010, such pages incorporated herein by reference.

In one broad embodiment, the present invention provides a process for co-reacting a glycidyl ether stream in an epoxidation reaction mixture and selectively converting at least a portion of the glycidyl ether-containing material to a desired H-PACE resin product.

In another embodiment, the present invention is directed to a process for preparing a hybrid aliphatic or cycloaliphatic epoxy resin including the steps of:
(I) reacting a mixture of (a) an aliphatic and/or cycloaliphatic hydroxyl-containing material, (b) a material selected from the group consisting of a MGE, a DGE, and combinations thereof (c) an epihalohydrin, (d) a basic acting substance, (e) a non-Lewis acid catalyst, and (f) optionally, a solvent, forming an epoxy resin composition, with the proviso that the aliphatic or cycloaliphatic hydroxyl-containing material used to prepare (b) is of a different chemical structure than (a);
(II) subjecting the epoxy resin composition produced in step (I) to a separation (fractionation) process to remove (A) “light” components such as, for example, solvent used in the epoxidation reaction, if any, unreacted epihalohydrin, and co-products such as di(epoxypropyl)ether; (B) unreacted aliphatic and/or cycloaliphatic hydroxyl-containing material, if any; (C) partially epoxidized aliphatic and/or cycloaliphatic hydroxyl-containing material(s), such as, for example, MGE(s); (D) fully epoxidized aliphatic and/or cycloaliphatic hydroxyl-containing material(s), such as, for example, DGE(s), such that the (E) H-PACE resin product remaining contains no more than 50% by weight of said fully epoxidized aliphatic and/or cycloaliphatic hydroxyl-containing material (D).

Basic acting substances which may be employed in the epoxidation process include alkali metal hydroxides, alkaline earth metal hydroxides, carbonates, bicarbonates, and any mixture thereof, and the like. More specific examples of the basic acting substance include sodium hydroxide, potassium hydroxide, lithium hydroxide, calcium hydroxide, barium hydroxide, magnesium hydroxide, manganese hydroxide, sodium carbonate, potassium carbonate, lithium carbonate, calcium carbonate, barium carbonate, magnesium carbonate, manganese carbonate, sodium bicarbonate, potassium bicarbonate, magnesium bicarbonate, lithium bicarbonate, calcium bicarbonate, barium bicarbonate, manganese bicarbonate, and any combination thereof. Sodium hydroxide and/or potassium hydroxide are the preferred basic acting substance.

Non-Lewis acid catalysts which may be employed in the epoxidation process include, for example, ammonium, phosphonium, or sulfonium salts. More specific examples of the catalyst include salts of the following ammonium, phosphonium and sulfonium cations: benzyltributylammonium, benzyltriethylammonium, benzyltrimethylammonium, tetrabutylammonium, tetraoctylammonium, tetramethylammonium, tetrabutylphosphonium, ethyltriphenylphosphonium, triphenylsulfonium, 4-tert-butoxyphenyldiphenylsulfonium, bis(4-tert-butoxyphenyl)phenylsulfonium, tris(4-tert-butoxyphenyl)sulfonium, 3-tert-butoxyphenyldiphenylsulfonium, bis(3-tert-butoxyphenyl)phenylsulfonium, tris(3-tert-butoxyphenyl)sulfonium, 3,4-di-tert-butoxyphenyldiphenylsulfonium, bis(3,4-di-tert-butoxyphenyl)phenylsulfonium, tris(3,4-di-tert-butoxyphenyl)sulfonium, diphenyl(4-thiophenoxyphenyl)sulfonium, 4-tert-butoxycarbonylmethyloxyphenyldiphenylsulfonium, tris(4-tert-butoxycarbonylmethyloxyphenyl)sulfonium, (4-tert-butoxyphenyl)bis(4-dimethylaminophenyl)sulfonium, tris(4-dimethyl-aminophenyl)sulfonium, 2-naphthyldiphenylsulfonium, (4-n-hexyloxy-3,5-dimethyl-phenyl)diphenylsulfonium, dimethyl(2-naphthyl)sulfonium, 4-methoxyphenyldimethylsulfonium, trimethylsulfonium, 2-oxocyclohexylcyclohexylmethylsulfonium, trinaphthylsulfonium, tribenzylsulfonium, diphenylmethylsulfonium, dimethylphenylsulfonium, 2-oxo-2-phenylethylthiacyclopentanium, diphenyl-2-thienylsulfonium, 4-n-butoxynaphthyl-1-thiacyclopentanium, 2-n-butoxynaphthyl-1-thiacyclopentanium, 4-methoxynaphthyl-1-thiacyclopentanium, and 2-methoxynaphthyl-1-thiacyclopentanium. Preferred cations are triphenylsulfonium, 4-tert-butylphenyldiphenylsulfonium, 4-tert-butoxyphenyldiphenylsulfonium, tris(4-tert-butylphenyl)sulfonium, tris(4-tert-butoxyphenyl)sulfonium, dimethylphenylsulfonium, and any combination thereof. Suitable quaternary phosphonium catalysts also include, for example, those quaternary phosphonium compounds disclosed in U.S. Pat. Nos. 3,948,855, 3,477,990 and 3,341,580 and Canadian Patent No. 858,648 all of which are incorporated herein by reference. Benzyltriethylammonium halides are the preferred catalyst, with benzyltriethylammonium chloride being most preferred.

The addition of the glycidyl ether-containing material (b) is performed into an epoxidation at any stage of aqueous alkaline agent (NaOH, for example) addition in the epoxidation in an epoxidation process using 2 or more stages of aqueous alkaline agent addition. In one embodiment of the present invention, addition of the glycidyl ether-containing material (b) is performed into an epoxidation specifically at the initial stage of aqueous alkaline agent addition in an epoxidation process using 2 or more stages of aqueous alkaline agent addition. In this embodiment the amount of H-PACE resin generally increases concurrent with increased reaction of glycidyl ether-containing material forming said H-PACE resin.

In another embodiment of the present invention, addition of the glycidyl ether-containing material (b) is performed into an epoxidation specifically at the final stage of aqueous alkaline agent addition in an epoxidation process using 2 or more stages of aqueous alkaline agent addition. In this embodiment the amount of H-PACE resin generally decreases concurrent with decreased reaction of glycidyl ether-containing material forming said H-PACE resin.

For the process of the present invention, the point of addition of the glycidyl ether-containing material (b) may be further defined by the extent of conversion of the hydroxyl-containing material (a), by the amount of the various epoxidation products present, the cumulative amount of aqueous alkaline reactant used, the amount of desired incorporation into the H-PACE resin product, or all of these.

One of the unique features of the present invention is that the chemical structure of the glycidyl ether-containing material (b) being reacted is different from the chemical structure of the aliphatic and/or cycloaliphatic hydroxyl-containing reactant (a) being epoxidized. Thus the process of the present invention produces novel H-PACE resin compositions containing different chemical structures that previously were unattainable. Highly useful properties are expected to result from co-reaction of reactants possessing different chemical structure into the epoxidation. The process of the present invention is broadly applicable to the production of a hybrid aliphatic and/or cycloaliphatic epoxy resin, especially and preferably those produced via non-Lewis acid catalyzed epoxidation.

The composition and relative amount of the moieties may be adjusted through (1) control of the chemical structure of the glycidyl ether-containing material (b) being reacted, (2) the different chemical structure of the aliphatic and/or cycloaliphatic hydroxyl-containing reactant (a) being epoxidized, (3) the amount of the glycidyl ether-containing material (b) reacted, (4) the stage of aqueous alkaline agent addition in the epoxidation process at which the glycidyl ether-containing material is added, (5) the reaction time and temperature profile, combinations thereof and other such variables which will be apparent to the skilled artisan.

The amount of the glycidyl ether-containing material used may vary as a function of the composition of said the glycidyl ether-containing material, the structure of said glycidyl ether-containing material, the performance desired in the thermoset of the H-PACE resin, as well as practical considerations, such as, for example, reactor volume. Thus, from about 0.01 mole to about 2 moles, preferably from about 0.1 mole to about 0.8 mole, most preferably from about 0.2 mole to about 0.5 mole of the glycidyl ether-containing material per mole of aliphatic and/or cycloaliphatic reactant used in the epoxidation is typically used.

In one preferred embodiment of the present invention addition of an aliphatic glycidyl ether stream as a reactant in the epoxidation of a cycloaliphatic or cycloaliphatic and aliphatic hydroxyl-containing reactant increases the amount of aliphatic structure in the resultant H-PACE resin. The increased aliphatic structure may be useful to enhance properties, for example, toughness, flexibility, impact resistance, resistance to cracking, ability to demold a part without damage, and the like in thermosets prepared from said H-PACE resin. A representative example, the addition of a mixture of MGE and DGE of hexanediol as a reactant in the epoxidation of cis-, trans-1,4-cyclohexanedimethanol as the hydroxyl-containing reactant, increases the amount of aliphatic structure in the resultant H-PACE resin.

In another preferred embodiment of the present invention addition of a cycloaliphatic glycidyl ether stream as a reactant in the epoxidation of an aliphatic hydroxyl-containing reactant increases the amount of aliphatic structure in the resultant H-PACE resin. The increased aliphatic structure may be useful to enhance properties, for example, glass transition temperature, hardness, abrasion resistance, flexural modulus, tensile modulus, and the like in thermosets prepared from said H-PACE resin. A representative example, the addition of a mixture of MGE and DGE of cyclohexanediol as a reactant in the epoxidation of hexanediol as the hydroxyl-containing reactant, increases the amount of cycloaliphatic structure in the resultant H-PACE resin.

The glycidyl ether-containing material may contain additional components. Fractions containing unreacted aliphatic or cycloaliphatic hydroxyl-containing reactant may additionally comprise the glycidyl ether-containing material used as a co-reactant for epoxidation. This unreacted aliphatic or cycloaliphatic hydroxyl-containing material may be epoxidized during the epoxidation of an aliphatic and/or cycloaliphatic hydroxyl-containing material thus providing in situ glycidyl ether-containing material for reaction to form the H-PACE resin. While typically not preferred, other components may be present as a part of the glycidyl ether-containing material, for example, one or more solvents which are inert to the epoxidation reaction.

The H-PACE resin may be re-epoxidized to produce a novel re-epoxidized H-PACE resin of the present invention. Re-epoxidation of PACE resin compositions and the re-epoxidation process for producing said compositions are disclosed in aforementioned co-pending U.S. patent application Ser. No. ______ (Attorney Docket No. 70043), filed Sep. 30, 2010. In the present invention the re-epoxidation process is conducted to modify the distribution of the components comprising said H-PACE resin. The re-epoxidation process of the present invention converts hydroxyl groups present in the H-PACE resin to glycidyl ether groups providing increased thermosettable functionality. Accordingly, one embodiment of the present invention is directed to an epoxy resin composition including the reaction product of (I) a hybrid polyfunctional aliphatic or cycloaliphatic epoxy (H-PACE) resin, (II) an epihalohydrin, and (III) a basic-acting substance, in the presence of (IV) a non-Lewis acid catalyst, and (V) optionally, one or more solvents.

The process of the present invention may be broadly applied to the production of H-PACE resins, especially and preferably those produced via non-Lewis acid catalyzed epoxidations. The process of the present invention advantageously provides a viable technology for handling isolated MGE-containing product inherently produced in a process used to recover high purity DGE from an aliphatic and/or cycloaliphatic epoxy resin.

A representative example of an embodiment of a process of the present invention to produce the novel H-PACE resins of the present invention may be where the aliphatic and/or cycloaliphatic hydroxyl-containing material (a) being epoxidized is UNOXOL™ Diol (cis-, trans-1,3- and 1,4-cyclohexanedimethanol) and the glycidyl ether-containing material (b) is a mixture of neopentyl glycol MGE and DGE.

Another embodiment of the present invention concerns a thermosettable (curable) epoxy resin composition comprising one or more (A) H-PACE resins or re-epoxidized H-PACE resins, one or more (B) epoxy resin curing agents and/or epoxy resin curing catalysts; and optionally, one or more (C) epoxy resins other than the H-PACE resin or re-epoxidized H-PACE resin (A). The term “thermosettable” (also referred to as “curable”) means that the composition is capable of being subjected to conditions which will render the composition to a thermoset or cured state or condition. The term “cured” or “thermoset” is defined by L. R. Whittington in Whittington's Dictionary of Plastics (1968) on page 239 as follows: “Resin or plastics compounds which in their final state as finished articles are substantially infusible and insoluble. Thermosetting resins are often liquid at some stage in their manufacture or processing, which are cured by heat, catalysis, or some other chemical means. After being fully cured, thermosets cannot be resoftened by heat. Some plastics which are normally thermoplastic can be made thermosetting by means of crosslinking with other materials.”

The thermosettable epoxy resin composition of the present invention is prepared by admixing a (a) H-PACE resin or re-epoxidized H-PACE resin composition of the present invention, with an (b) epoxy resin curing agent and/or a curing catalyst; and optionally, an (c) epoxy resin other than the H-PACE resin or re-epoxidized H-PACE resin composition (a). The curing agent and/or curing catalyst are used in amounts which will effectively thermoset the curable epoxy resin composition, with the understanding that the amounts will depend upon the specific H-PACE resin or re-epoxidized H-PACE resin, any optionally used epoxy resin, and the curing agent and/or catalyst employed. Generally, the ratio of the curing agent and the H-PACE resin and epoxy resin other than the re-epoxidized PACE resin, if used, is from about 0.60:1 to about 1.50:1, and preferably from about 0.95:1 to about 1.05:1 equivalents of reactive hydrogen atom present in the curing agent per equivalent of epoxide group in the epoxy resin(s) at the conditions employed for curing.

A preferred curable epoxy resin composition of the present invention comprises an aliphatic and/or cycloaliphatic curing agent and the H-PACE resin or re-epoxidized H-PACE resin. The curable epoxy resin composition, when cured, provides a cured epoxy resin free of any aromatic group. A more specific preferred curable epoxy resin composition of the present invention comprises an alkyleneamine (polyalkylenepolyamine) curing agent, such as, for example, diethylenetriamine or triethylenetetramine, and the H-PACE resin or re-epoxidized H-PACE resin. The curable epoxy resin composition, when cured, provides a cured epoxy resin free of any aromatic group.

Another preferred curable epoxy resin composition of the present invention comprises the (1) aliphatic and/or cycloaliphatic curing agent, (2) the H-PACE

resin or re-epoxidized H-PACE resin and (3) an epoxy resin other than the H-PACE resin or re-epoxidized H-PACE resin wherein the epoxy resin (3) comprises one or more of aliphatic and/or cycloaliphatic epoxy resins. The curable epoxy resin composition, when cured, provides a cured epoxy resin free of any aromatic group. A more specific preferred curable epoxy resin composition of the present invention comprises (1) an alkyleneamine (polyalkylenepolyamine) curing agent, (2) the H-PACE resin or re-epoxidized H-PACE resin and (3) an epoxy resin other than the H-PACE resin or re-epoxidized H-PACE resin wherein the epoxy resin (3) comprises one or more of aliphatic and/or cycloaliphatic epoxy resins. The curable epoxy resin composition, when cured, provides a cured epoxy resin free of any aromatic group.

The epoxy resin curing agent and/or curing catalyst used in the present invention to form the thermosettable mixture with the H-PACE resin or re-epoxidized H-PACE resin comprises at least one material having two or more reactive hydrogen atoms per molecule. The reactive hydrogen atoms are reactive with epoxide groups, such as those epoxide groups contained in the H-PACE resin or re-epoxidized H-PACE resin. Certain of the hydrogen atoms can be non-reactive with the epoxide groups in the initial process of forming the cured product but reactive in a later process of curing the epoxy resin, when there are other functional groups, which are much more reactive with the epoxide groups under reaction conditions used, present in the B-staging or thermosetting reaction of forming the thermoset product. For example, a reactive compound may have two different functional groups each bearing at least one reactive hydrogen atom, with one functional group being inherently more reactive with an epoxide group than the other under the reaction conditions used. These reaction conditions may include the use of a catalyst which favors a reaction of the reactive hydrogen atom(s) of one functional group with an epoxide group over a reaction of the reactive hydrogen atom(s) of the other functional group with an epoxide group. The catalyst may also be latent, for example under conditions of mixing the thermosettable mixture, then activated at a later time, for example by heating of the latently catalyzed thermosettable mixture. Other non-reactive hydrogen atoms may also include hydrogen atoms in the secondary hydroxyl groups which form during an epoxide ring opening reaction in the process of producing the partially cured or fully cured product.

The curing agent may further comprise aliphatic, cycloaliphatic and/or aromatic groups within the curing agent structure. The aliphatic groups may be branched or unbranched. The aliphatic or cycloaliphatic groups may also be saturated or unsaturated and may comprise one or more substituents which are inert (not reactive) to the process of preparing the thermosettable compositions and thermosets of the present invention. The substituents may be attached to a terminal carbon atom or may be between two carbon atoms, depending on the chemical structures of the substituents. Examples of such inert substituents include halogen atoms, preferably chlorine or bromine, nitrile, nitro, alkyloxy, keto, ether (—O—), thioether (—S—), or tertiary amine. The aromatic ring, if present within the curing agent structure, may comprise one or more heteroatoms such as N, O, S and the like.

Examples of the curing agent may include compounds such as (a) di- and polyphenols, (b) di- and polycarboxylic acids, (c) di- and polymercaptans, (d) di- and polyamines, (e) primary monoamines, (f) sulfonamides, (g) aminophenols (h) aminocarboxylic acids, (i) phenolic hydroxyl containing carboxylic acids, (j) sulfanilamides, and (k) any combination of any two or more of such compounds or the like.

Examples of the di- and polyphenols (a) include 1,2-dihydroxybenzene (catechol); 1,3-dihydroxybenzene (resorcinol); 1,4-dihydroxybenzene (hydroquinone); 4,4′-isopropylidenediphenol (bisphenol A); 4,4′-dihydroxydiphenylmethane; 3,3′,5,5′-tetrabromobisphenol A; 4,4′-thiodiphenol; 4,4′-sulfonyldiphenol; 2,2′-sulfonyldiphenol; 4,4′-dihydroxydiphenyl oxide; 4,4′-dihydroxybenzophenone; 1,1′-bis(4 hydroxyphenyl)-1-phenylethane; 3,3′,5,5′-tetrachlorobisphenol A; 3,3′-dimethoxybisphenol A; 3,3′,5,5′-tetramethyl-4,4′-dihydroxydiphenyl;

4,4′-dihydroxybiphenyl; 4,4′-dihydroxy-alpha-methylstilbene; 4,4′-dihydroxybenzanilide; 4,4′-dihydroxystilbene; 4,4′-dihydroxy-alpha-cyanostilbene; 1,1-bis(4-hydroxyphenyl)cyclohexane; 1,4-dihydroxy-3,6-dimethylbenzene; 1,4-dihydroxy-3,6-dimethoxybenzene; 1,4-dihydroxy-2-tert-butylbenzene; 1,4-dihydroxy-2-bromo-5-methylbenzene; 1,3-dihydroxy-4-nitrophenol; 1,3-dihydroxy-4-cyanophenol; tris(hydroxyphenyl)methane, dicyclopentadiene or an oligomer thereof and phenol or substituted phenol condensation products, and any mixture thereof.

Examples of the di- and polycarboxylic acids (b) include terephthalic acid, isophthalic acid, dicyclopentadienedicarboxylic acid, tris(carboxyphenyl)methane, 4,4′-dicarboxydiphenylmethane; 1,4-cyclohexanedicarboxylic acid; 1,6-hexanedicarboxylic acid; 1,4 butanedicarboxylic acid; 1,1-bis(4-carboxyphenyl)cyclohexane; 3,3′,5,5′-tetramethyl-4,4′-dicarboxydiphenyl; 4,4′-dicarboxy-alpha-methylstilbene; 1,4-bis(4-carboxyphenyl)-trans-cyclohexane; 1,1′-bis(4-carboxyphenyl)cyclohexane; 1,3-dicarboxy-4-methylbenzene; 1,3-dicarboxy-4-methoxybenzene; 1,3 dicarboxy-4-bromobenzene; and any combination thereof.

Examples of the di- and polymercaptans (c) include 1,3-benzenedithiol; 1,4-benzenedithiol; 4,4′-dimercaptodiphenylmethane; 4,4′-dimercaptodiphenyl oxide; 4,4′-dimercapto-alpha-methylstilbene; 3,3′,5,5′-tetramethyl-4,4′-dimercaptodiphenyl; 1,4-cyclohexanedithiol; 1,6-hexanedithiol; 2,2′-dimercaptodiethylether; 1,1-bis(4-mercaptophenyl)cyclohexane; 1,2-dimercaptopropane, bis(2-mercaptoethyl)sulfide, tris(mercaptophenyl)methane, and any combination thereof.

Examples of the di- and polyamines (d) include 1,2-diaminobenzene; 1,3-diaminobenzene; 1,4-diaminobenzene; 4,4′-diaminodiphenylmethane; 4,4′-diaminodiphenylsulfone; 2,2′-diaminodiphenylsulfone; 4,4′-diaminodiphenyl oxide; 3,3′,5,5′-tetramethyl-4,4′-diaminodiphenyl; 3,3′-dimethyl-4,4′-diaminodiphenyl; 4,4′-diamino-alpha-methylstilbene; 4,4′-diaminobenzanilide; 4,4′-diaminostilbene; 1,4-bis(4-aminophenyl)-trans-cyclohexane; 1,1-bis(4-aminophenyl)cyclohexane; 1,2-cyclohexanediamine; 1,4-bis(aminocyclohexyl)methane; 1,3-bis(aminomethyl)cyclohexane; 1,4-bis(aminomethyl)cyclohexane; 1,4-cyclohexanediamine; 1,6-hexanediamine; 2,2′-bis(4-aminocyclohexyl)propane; 4-(2-aminopropan-2-yl)-1-methylcyclohexan-1-amine (menthane diamine); piperazine, ethylenediamine, diethyletriamine, triethylenetetramine, tetraethylenepentamine, 1-(2-aminoethyl)piperazine, bis(aminopropyl)ether, bis(aminopropyl)sulfide, bis(aminomethyl)norbornane, isophoronediamine, 1,3-xylenediamine, tris(aminophenyl)methane, and any combination thereof.

Examples of the primary monoamines (e) include ammonia, aniline, 4-chloroaniline, 4-methylaniline, 4-methoxyaniline, 4-cyanoaniline, 4-aminodiphenyl oxide, 4-aminodiphenylmethane, 4-aminodiphenylsulfide, 4-aminobenzophenone, 4-aminodiphenyl, 4-aminostilbene, 4-amino-alpha-methylstilbene, methylamine, 4-amino-4′-nitrostilbene, n-hexylamine, cyclohexylamine, aminonorbornane, N,N-diethyltrimethylenediamine; 2,6-dimethylaniline; and any combination thereof.

Examples of the sulfonamides (f) include phenylsulfonamide, 4-methoxyphenylsulfonamide, 4-chlorophenylsulfonamide, 4-bromophenylsulfonamide, 4-methylsulfonamide, 4-cyanosulfonamide, 4-sulfonamidodiphenyl oxide, 4-sulfonamidodiphenylmethane, 4 sulfonamidobenzophenone, 4-sulfonylamidodiphenyl, 4-sulfonamidostilbene, 4-sulfonamido-alpha-methylstilbene, 2,6-dimethyphenylsulfonamide; and any combination thereof.

Examples of the aminophenols (g) include o-aminophenol, m-aminophenol, p-aminophenol, 2-methoxy-4-hydroxyaniline, 3-cyclohexyl-4-hydroxyaniline, 5-butyl-4-hydroxyaniline, 3-phenyl-4-hydroxyaniline, 4-(1-(3-aminophenyl)-1-methylethyl)phenol, 4-(1-(4-aminophenyl)ethyl)phenol, 4-(4-aminophenoxy)phenol, 4-((4-aminophenyl)thio)phenol, (4-aminophenyl)(4-hydroxyphenyl)methanone, 4-((4-aminophenyl)sulfonyl)phenol, N-methyl-p-aminophenol, 4-amino-4′-hydroxy-alpha-methylstilbene, 4-hydroxy-4′-amino-alpha-methylstilbene, 4-(1-(4-amino-3,5-dibromophenyl)-1-methylethyl)-2,6-dibromophenol; 3,5-dimethyl-4-hydroxyaniline; 2,6-dibromo-4-hydroxyaniline; and any combination thereof.

Examples of the aminocarboxylic acids (h) include 2-aminobenzoic acid, 3-aminobenzoic acid, 4-aminobenzoic acid, 2-methoxy-4-aminobenzoic acid, 3-cyclohexyl-4-aminobenzoic acid, 5-butyl-4-aminobenzoic acid, 3-phenyl-4-aminobenzoic acid, 4-(1-(3-aminophenyl)-1-methylethyl)benzoic acid, 4-(1-(4-aminophenyl)ethyl)benzoic acid, 4-(4-aminophenoxy)benzoic acid, 4-((4-aminophenyl)thio)benzoic acid, (4-aminophenyl)(4-carboxyphenyl)methanone, 4-((4-aminophenyl)sulfonyl)benzoic acid, N-methyl-4-aminobenzoic acid, 4-amino-4′-carboxy-alpha-methylstilbene, 4-carboxy-4′-amino-alpha-methylstilbene, glycine, N-methylglycine, 4-aminocyclohexanecarboxylic acid, 4-aminohexanoic acid, 4-piperidinecarboxylic acid, 5-aminophthalic acid, 4-(1-(4-amino-3,5-dibromophenyl)-1-methylethyl)-2,6-dibromobenzoic acid; 3,5-dimethyl-4-aminobenzoic acid; 2,6-dibromo-4-aminobenzoic acid; and any combination thereof.

Examples of the carboxylic acids (i) include 2-hydroxybenzoic acid, 3-hydroxybenzoic acid, 4-hydroxybenzoic acid, 2-methoxy-4-hydroxybenzoic acid, 3-cyclohexyl-4-hydroxybenzoic acid, 5-butyl-4-hydroxybenzoic acid, 3-phenyl-4-hydroxybenzoic acid, 4-(1-(3-hydroxyphenyl)-1-methylethyl)benzoic acid, 4-(1-(4-hydroxyphenyl)ethyl)benzoic acid, 4-(4-hydroxyphenoxy)benzoic acid, 4-((4-hydroxyphenyl)thio)benzoic acid, (4-hydroxyphenyl)(4-carboxyphenyl)methanone, 4-((4-hydroxyphenyl)sulfonyl)benzoic acid, 4-hydroxy-4′-carboxy-alpha-methylstilbene, 4-carboxy-4′-hydroxy-alpha-methylstilbene, 2-hydroxyphenylacetic acid, 3-hydroxyphenylacetic acid, 4-hydroxyphenylacetic acid, 4-hydroxyphenyl-2-cyclohexanecarboxylic acid, 4-hydroxyphenoxy-2-propanoic acid, 3,5-dimethyl-4-hydroxybenzoic acid; 2,6-dibromo-4-hydroxybenzoic acid; 4-(1-(4-hydroxy-3,5-dibromophenyl)-1-methylethyl)-2,6-dibromobenzoic acid; and any combination thereof.

Examples of the sulfanilamides (j) include o-sulfanilamide, m-sulfanilamide, p-sulfanilamide, 2-methoxy-4-aminobenzoic acid, 3-methyl-4-sulfonamido-1-aminobenzene, 5-methyl-3-sulfonamido-1-aminobenzene, 3-phenyl-4-sulfonamido-1-aminobenzene, 4-(1-(3-sulfonamidophenyl)-1 methylethyl)aniline, 4-(1-(4-sulfonamidophenyl)ethyl)aniline, 4-(4-sulfonamidophenoxy)aniline, 4-((4-sulfonamidophenyl)thio)aniline, (4-sulfonamidophenyl)(4-aminophenyl)methanone, 4-((4 sulfonamidophenyl)sulfonyl)aniline, 4-sulfonamido-1-N-methylaminobenzene, 4-amino-4′-sulfonamido-alpha-methylstilbene, 4-sulfonamido-4′-amino-alpha-methylstilbene, 2,6-dimethyl-4-sulfonamido-1-aminobenzene; 4-(1-(4-sulfonamido-3,5-dibromophenyl)-1-methylethyl)-2,6-dibromoaniline; and any combination thereof.

Particularly preferred examples of the curing catalyst include boron trifluoride, boron trifluoride etherate, aluminum chloride, ferric chloride, zinc chloride, silicon tetrachloride, stannic chloride, titanium tetrachloride, antimony trichloride, boron trifluoride monoethanolamine complex, boron trifluoride triethanolamine complex, boron trifluoride piperidine complex, pyridine-borane complex, diethanolamine borate, zinc fluoroborate, metallic acylates such as stannous octoate or zinc octoate, and any combination thereof.

The curing catalyst may be employed in an amount which will effectively thermoset the curable epoxy resin composition or assist in the thermosetting of the thermosettable epoxy resin composition. The amount of the curing catalyst will also depend upon the particular H-PACE resin or re-epoxidized H-PACE resin, the curing agent, if any, and epoxy resin other than the H-PACE resin or re-epoxidized H-PACE resin, if any, employed in the thermosettable epoxy resin composition. Generally, the curing catalyst may be used in an amount of from about 0.001 wt % to about 2 wt %, based on the weight of the total thermosettable epoxy resin composition. In addition, one or more of the curing catalysts may be employed to accelerate or otherwise modify the curing process of the curable epoxy resin composition.

The epoxy resin which can optionally be used as the epoxy resin (c) other than the H-PACE or re-epoxidized H-PACE resin (a) may be any epoxide containing compound which has an average of more than one epoxide group per molecule. The epoxide group can be attached to any oxygen, sulfur or nitrogen atom or the single bonded oxygen atom attached to the carbon atom of a —CO—O— group. The oxygen, sulfur, nitrogen atom, or the carbon atom of the —CO—O— group may be attached to an aliphatic, cycloaliphatic, polycycloaliphatic or aromatic hydrocarbon group. The aliphatic, cycloaliphatic, polycycloaliphatic or aromatic hydrocarbon group can be substituted with any inert substituents including, but not limited to, halogen atoms, preferably fluorine, bromine or chlorine; nitro groups; or the groups can be attached to the terminal carbon atoms of a compound containing an average of more than one —(O—CHRa-CHRa)t- group, wherein each Ra is independently a hydrogen atom or an alkyl or haloalkyl group containing from one to two carbon atoms, with the proviso that only one Ra group can be a haloalkyl group, and t has a value from one to about 100, preferably from one to about 20, more preferably from one to about 10, and most preferably from one to about 5. More specific examples of the epoxy resin which can be used as the epoxy resin (c) include diglycidyl ethers of 1,2-dihydroxybenzene (catechol); 1,3-dihydroxybenzene (resorcinol); 1,4-dihydroxybenzene (hydroquinone); 30 4,4′-isopropylidenediphenol (bisphenol A); 4,4′-dihydroxydiphenylmethane; 3,3′,5,5′-tetrabromobisphenol A; 4,4′-thiodiphenol; 4,4′-sulfonyldiphenol; 2,2′-sulfonyldiphenol; 4,4′-dihydroxydiphenyl oxide; 4,4′-dihydroxybenzophenone; 1,1′-bis(4-hydroxyphenyl)-1-phenylethane; 3,3′-5,5′-tetrachlorobisphenol A; 3,3′-dimethoxybisphenol A; 4,4′-dihydroxybiphenyl; 4,4′-dihydroxy-alpha-methylstilbene; 4,4′-dihydroxybenzanilide; 4,4′-dihydroxystilbene; 4,4′-dihydroxy-alpha-cyanostilbene; N,N′-bis(4-hydroxyphenyl)terephthalamide; 4,4′-dihydroxyazobenzene; 4,4′-dihydroxy-2,2′-dimethylazoxybenzene; 4,4′-dihydroxydiphenylacetylene; 4,4′-dihydroxychalcone; the tetraglycidyl amines of 4,4′-diaminodiphenylmethane; 4,4′-diaminostilbene; 5 N,N′-dimethyl-4,4′-diaminostilbene; 4,4′-diaminobenzanilide; 4,4′-diaminobiphenyl; 4-hydroxyphenyl-4-hydroxybenzoate, dipropylene glycol, poly(propylene glycol), thiodiglycol, the triglycidyl ether of tris(hydroxyphenyl)methane, the polyglycidyl ethers of a phenol or alkyl or halogen substituted phenol-aldehyde acid catalyzed condensation product (novolac resins), the polyglycidyl ether of the condensation product of a dicyclopentadiene or an oligomer thereof and a phenol or alkyl or halogen substituted phenol, and any combination thereof.

The epoxy resin which can be used as the epoxy resin may also include an advanced epoxy resin product. The advanced epoxy resin may be a product of an advancement reaction of an epoxy resin with an aromatic di- and polyhydroxyl, or carboxylic acid containing compound. The epoxy resin used in the advancement reaction may include any one or more of the aforesaid epoxy resins suitable for the epoxy resin comprising the di- or polyglycidyl ethers. Examples of the aromatic di- and polyhydroxyl or carboxylic acid containing compound include 4,4′-dihydroxydiphenylmethane; 4,4′-thiodiphenol; 4,4′-sulfonyldiphenol; 2,4-dimethylresorcinol; 2,2′-sulfonyldiphenol; 4,4′-dihydroxydiphenyl oxide; 4,4′-dihydroxybenzophenone; 1,1-bis(4-hydroxyphenyl)-1-phenylethane; 4,4′-bis(4(4-hydroxyphenoxy)-phenylsulfone)diphenyl ether; 4,4′-dihydroxydiphenyl disulfide; 3,3′,3,5′-tetrachloro-4,4′-isopropylidenediphenol; 3,3′,3,5′-tetrabromo-4,4′-isopropylidenediphenol; 3,3′-dimethoxy-4,4′-isopropylidenediphenol; 4,4′-dihydroxybiphenyl; 4,4′-dihydroxy-alpha-methylstilbene; 4,4′-dihydroxybenzanilide; bis(4-hydroxyphenyl)terephthalate; N,N′-bis(4-hydroxyphenyl)terephthalamide; 4,4′-dihydroxyphenylbenzoate; bis(4′-hydroxyphenyl)-1,4-benzenediimine; 1,1′-bis(4-hydroxyphenyl)cyclohexane; 2,2′,5,5′-tetrahydroxydiphenylsulfone; bis(4′-hydroxybiphenyl)terephthalate; 4,4′-benzanilidedicarboxylic acid; 4,4′-phenylbenzoatedicarboxylic acid; 4,4′-stilbenedicarboxylic acid, hydroquinone, resorcinol, catechol, 4-chlororesorcinol, tetramethylhydroquinone, bisphenol A, phloroglucinol, pyrogallol, tris(hydroxyphenyl)methane, dicyclopentadiene diphenol, tricyclopentadienediphenol, terephthalic acid, isophthalic acid, adipic acid, and any combination thereof.

Preparation of the aforementioned advanced epoxy resin products can be performed using known methods, for example, an advancement reaction of an epoxy resin with one or more suitable compounds having an average of more than one reactive hydrogen atom per molecule, wherein the reactive hydrogen atom is reactive with an epoxide group in the epoxy resin. The ratio of the compound having an average of more than one reactive hydrogen atom per molecule to the epoxy resin is generally from about 0.01:1 to about 0.95:1, preferably from about 0.05:1 to about 0.8:1, and more preferably from about 0.10:1 to about 0.5:1 equivalents of the reactive hydrogen atom per equivalent of the epoxide group in the epoxy resin. In addition to the aforementioned dihydroxyaromatic and dicarboxylic acid compounds, examples of the compound having an average of more than one reactive hydrogen atom per molecule may also include dithiol, disulfonamide or compounds containing one primary amine or amide group, two secondary amine groups, one secondary amine group and one phenolic hydroxy group, one secondary amine group and one carboxylic acid group, or one phenolic hydroxy group and one carboxylic acid group, and any combination thereof.

The advancement reaction may be conducted in the presence or absence of a solvent with the application of heat and mixing. The advancement reaction may be conducted at atmospheric, superatmospheric or subatmospheric pressures and at temperatures of from about 20° C. to about 260° C., preferably, from about 80° C. to about 240° C., and more preferably from about 100° C. to about 200° C. The time required to complete the advancement reaction depends upon factors such as the temperature employed, the chemical structure of the compound having more than one reactive hydrogen atom per molecule employed, and the chemical structure of the epoxy resin employed. Higher temperature may require shorter reaction time whereas lower temperature requires a longer period of reaction time. In general, the time for completion of the advancement reaction may range from about 5 minutes to about 24 hours, preferably from about 30 minutes to about 8 hours, and more preferably from about 30 minutes to about 4 hours.

A catalyst may also be added in the advancement reaction. Examples of the catalyst may include phosphines, quaternary ammonium compounds, phosphonium compounds and tertiary amines. The catalyst may be employed in quantities of from about 0.01 wt % to about 3 wt %, preferably from about 0.03 wt % to about 1.5 wt %, and more preferably from about 0.05 wt % to about 1.5 wt %, based upon the total weight of the epoxy resin. Other details concerning an advancement reaction useful in preparing the advanced epoxy resin product for the resin are provided in U.S. Pat. No. 5,736,620 and in Handbook of Epoxy Resins by Henry Lee and Kris Neville, both of which are incorporated herein by reference.

The thermosettable epoxy resin composition may also be blended with at least one additive including, for example, a cure accelerator, a solvent or diluent, a modifier such as a flow modifier and/or a thickener, a reinforcing agent, a filler, a pigment, a dye, a mold release agent, a wetting agent, a stabilizer, a fire retardant agent, a surfactant, or any combination thereof. The additive may be blended with the H-PACE resin or re-epoxidized H-PACE resin, the curing agent, if used, and the epoxy resin other than the H-PACE resin or re-epoxidized H-PACE resin, if used or with any combination thereof prior to use for the preparation of the thermosettable epoxy resin composition of the present invention. These additives may be added in functionally equivalent amounts, for example, the pigment and/or dye may be added in quantities which will provide the composition with the desired color. In general, the amount of the additives may be from about zero wt % to about 20 wt %, preferably from about 0.5 wt % to about 5 wt %, and more preferably from about 0.5 wt % to about 3 wt %, based upon the total weight of the thermosettable epoxy resin composition.

The cure accelerator which can be employed herein includes, for example, mono, di, tri and tetraphenols; chlorinated phenols; aliphatic or cycloaliphatic mono or dicarboxylic acids; aromatic carboxylic acids; hydroxybenzoic acids; halogenated salicylic acids; boric acid; aromatic sulfonic acids; imidazoles; tertiary amines; aminoalcohols; aminopyridines; aminophenols; mercaptophenols; and any mixture thereof. Particularly suitable cure accelerators include 2,4-dimethylphenol, 2,6-dimethylphenol, 4-methylphenol, 4-tertiary-butylphenol, 2-chlorophenol, 4-chlorophenol, 2,4-dichlorophenol, 4-nitrophenol, 1,2-dihydroxybenzene, 1,3-dihydroxybenzene, 2,2′-dihydroxybiphenyl, 4,4′-isopropylidenediphenol, valeric acid, oxalic acid, benzoic acid, 2,4-dichlorobenzoic acid, 5-chlorosalicylic acid, salicylic acid, p-toluenesulfonic acid, benzenesulfonic acid, hydroxybenzoic acid, 4-ethyl-2-methylimidazole, 1-methylimidazole, triethylamine, tributylamine, N,N-diethylethanolamine, N,N-dimethylbenzylamine, 2,4,6-tris(dimethylamino)phenol, 4-dimethylaminopyridine, 4-aminophenol, 2-aminophenol, 4-mercaptophenol, and any combination thereof.

Examples of the solvent or diluent which can be employed herein include, for example, aliphatic and aromatic hydrocarbons, halogenated aliphatic hydrocarbons, aliphatic ethers, aliphatic nitriles, cyclic ethers, glycol ethers, esters, ketones, amides, sulfoxides, and any combination thereof. Particularly suitable solvents include pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, diethylene glycol methyl ether, dipropylene glycol methyl ether, N-methylpyrrolidinone, N,N-dimethylacetamide, acetonitrile, sulfolane, and any combination thereof.

The modifier such as the thickener and the flow modifier may be employed in amounts of from zero wt % to about 10 wt %, preferably, from about 0.5 wt % to about 6 wt %, and more preferably from about 0.5 wt % to about 4 wt %, based upon the total weight of the thermosettable epoxy resin blend composition. The reinforcing material which may be employed herein includes natural and synthetic fibers in the form of woven fabric, mat, monofilament, multifilament, unidirectional fiber, roving, random fiber or filament, inorganic filler or whisker, or hollow sphere. Other suitable reinforcing material includes glass, carbon, ceramics, nylon, rayon, cotton, aramid, graphite, polyalkylene terephthalates, polyethylene, polypropylene, polyesters, and any combination thereof.

The filler which may be employed herein includes, for example, inorganic oxide, ceramic microsphere, plastic microsphere, glass microsphere, inorganic whisker, calcium carbonate, and any combination thereof. The filler may be employed in an amount of from zero wt % to about 95 wt %, preferably from about 10 wt % to about 80 wt %, and more preferably from about 40 wt % to about 60 wt %, based upon the total weight of the thermosettable epoxy resin composition.

Another embodiment of the present invention comprises a partially (B-staged) or a totally cured (thermoset) product from the thermosettable epoxy resin composition described above. The process of thermosetting the thermosettable epoxy resin composition of the present invention may be conducted at atmospheric (e.g. 760 mm Hg), superatmospheric or subatmospheric pressures and at a temperature from about 0° C. to about 300° C., preferably from about 25° C. to about 250° C., and more preferably from about 50° C. to about 200° C. The time required to complete the curing may depend upon the temperature employed. Higher temperatures generally require a shorter period of time whereas lower temperatures generally require longer periods of time. In general, the required time for completion of the curing is from about 1 minute to about 48 hours, preferably from about 15 minutes to about 24 hours, and more preferably from about 30 minutes to about 12 hours. It is also operable to partially thermoset the thermosettable epoxy resin composition of the present invention to form a B-stage product and subsequently cure the B-stage product completely at a later time.

Another embodiment of the present invention comprises an article prepared from the B-staged (partially thermoset) or the totally cured (thermoset) product described above. The article may include, for example, coatings, especially protective coatings with excellent solvent resistant, moisture resistant, abrasion resistant, impact resistant, and weatherable (e.g., UV resistant, non-chalking) properties; a reactive toughener for thermosets including epoxy resin based thermosets; can and coil coatings; maintenance coatings including coatings for stone, concrete and flooring; marine coatings including anti-fouling coatings; powder coatings including both decorative and functional types; automotive coatings; corrosion resistant coatings; electrical or structural laminates and composites; encapsulations; general castings; coatings for other plastics and metals; sealants; filament windings; moldings; polymer modified concrete; binders; adhesives including window glass adhesives; paints lacquers, and varnishes. Articles which comprise a fully aliphatic/cycloaliphatic cured epoxy resin (with no aromatic rings) of the present invention are especially desirable for their outstanding balance of physical and mechanical properties.

### EXAMPLES

The following Examples and Comparative Examples further illustrate the present invention in detail but are not to be construed to limit the scope thereof.

The following standard abbreviations are used in the Examples and Comparative Examples: “MGE” stands for monoglycidyl ether(s), “DGE” stands for diglycidyl ether(s), “GC” stands for gas chromatography (chromatographic); “MS” stands for mass spectrometry (spectrometric, spectra); “EEW” stands for epoxide equivalent weight; “DI” stands for deionized; “eq” stands for equivalent(s); “wt” stands for weight(s); “vol” stands for volume(s); “min” stands for minute(s); “hr” stands for hour(s); “g” stands for gram(s); “mL” stands for milliliter(s); “L” stands for liter(s); “LPM” stands for liter(s) per minute; “μm” stands for micrometer(s); “mm” stands for millimeter(s); “m” stands for meter(s); and “cp” stands for centipoise.

In the following Examples and Comparative Examples, standard analytical equipment and methods are used such as for example, the following:

Differential Scanning calorimetry (DSC)

For analysis of curing of the thermosettable blend of the H-PACE resin and DETA of the present invention a DSC 2910 Modulated DSC (TA Instruments) was employed, using a heating rate of 7° C. per min from 0° C. to 250° C. under a stream of nitrogen flowing at 35 cubic centimeters per min. The sample was contained in an aluminum pan and loosely covered (not sealed) with an aluminum lid. The sample weight tested is given with the results obtained. For analysis of Tg of the thermosettable blend of the H-PACE resin and DETA the aforementioned parameters were again employed. The sample was contained in an open aluminum pan.

### I.C.I. Cone and Plate Viscosity

Viscosity was determined on an I.C.I. Cone and Plate Viscometer Viscosity (model VR-4540) at 25° C. In the method, the viscometer equipped with a 0-40 poise spindle (model VR-4140) and equilibrated to 25° C. was calibrated to zero then the sample applied and held 2 min with viscosity then checked and the reading taken after 15 seconds. One or more duplicate viscosity tests were completed using a fresh aliquot of the particular product being tested. The individual measurements were averaged.

### Percent Epoxide/Epoxide Equivalent Weight Analysis

A standard titration method was used to determine percent epoxide in the various epoxy resins [Jay, R. R., “Direct Titration of Epoxy Compounds and Aziridines”, Analytical Chemistry, 36, 3, 667-668 (March, 1964).] In the present adaptation of this method, the carefully weighed sample (sample weight ranges from 0.17-0.25 g) was dissolved in dichloromethane (15 mL) followed by the addition of tetraethylammonium bromide solution in acetic acid (15 mL). The resultant solution treated with 3 drops of crystal violet indicator (0.1% wt/vol in acetic acid) was titrated with 0.1N perchloric acid in acetic acid on a Metrohm 665 Dosimat titrator (Brinkmann). Titration of a blank consisting of dichloromethane (15 mL) and tetraethylammonium bromide solution in acetic acid (15 mL) provided correction for solvent background. Percent epoxide and EEW were calculated using the following equations:

$$\% Epoxide = \frac{⌈ ( mL titrated sample ) - ( mL titrated blank ) ⌉ ( 0.04303 )}{( g sample titrated )}$$

$$EEW = \frac{4303}{\% epoxide}$$

### Gas Chromatographic Analysis: Area %

In the general method, a Hewlett Packard 5890 Series II Plus gas chromatograph was employed using a DB-1 capillary column (61.4 m by 0.25 mm with a 0.25 μm film thickness, Agilent). The column was maintained in the chromatograph oven at a 50° C. initial temperature. Both the injector inlet and flame ionization detector were maintained at 300° C. Helium carrier gas flow through the column was maintained at 1.1 mL per min. For the analyses of the epoxy resins during synthesis or from the rotary evaporation, an initial 50° C. oven temperature with heating at 12° C. per min to a final temperature of 300° C. revealed that essentially all light boiling components, including residual epichlorohydrin, cyclohexanedimethanols and monoglycidyl ethers of the cyclohexanedimethanols had been removed by the rotary evaporation. For the analyses of the PACE and H-PACE resins, an initial 250° C. oven temperature with heating at 13.3° C. per min to a final temperature of 300° C. was employed for complete elution of all oligomeric components within 50 min total time for the analysis. GC analyses in area % are not a quantitative measure of any given component.

Samples for GC analysis were prepared by collection of a 0.5 mL aliquot of the slurry product from the epoxidation and addition to a vial containing 1 mL of acetonitrile. After shaking to mix, a portion of the slurry in acetonitrile was loaded into a

1 mL syringe (Norm-Ject, all polypropylene/polyethylene, Henke Sass Wolf GmbH) and passed through a syringe filter (Acrodisc CR 13 with 0.2 μm PTFE membrane, Pall Corporation, Gelman Laboratories) to remove inorganic any insoluble debris.
Internally Standardized Gas Chromatographic Analysis for Weight Percent Residual Diglycidyl Ethers of cis-, trans-1,3- and 1,4-Cyclohexanedimethanol in the PACE and H-PACE Resins

A single point internal standard method was developed for GC analysis of residual DGE of cis-, trans-1,3- and 1,4-cyclohexanedimethanol remaining in the distillation pot product (PACE and H-PACE resins). Cyclohexanone was selected as the internal standard since it had a retention time that was different from that of any other components observed in the analyses of the epoxidation products. For the analyses using an internal standard, an initial 50° C. oven temperature with heating at 12° C. per min to a final temperature of 300° C. was employed. For the standard of the DGE of cis-, trans-1,3- and 1,4-cyclohexanedimethanol, a distillation cut was employed. This distillation cut contained 0.71 wt % MGE and 99.29 wt % DGE. A 0.2500 g sample of the standard plus 0.7500 g of acetonitrile plus 5 μL of cyclohexanone weighing 0.0047 g. were added to a glass vial. Three separate injections were made in the gas chromatograph and the resultant area counts were averaged for the cyclohexanone and for the DGE. This data was used to calculate the internal response factor, as follows:

$$Internal Response Factor = \frac{( area internal standard ) ( amount diglycidyl ethers )}{( amount internal standard ) ( area diglycidyl ethers )}$$

An aliquot (approximately 0.2500 g) of the PACE resin, acetonitrile (approximately 0.7500 g) and cyclohexanone (5 μL, approximately 0.0047 g) were added to a glass vial and analyzed by GC. Using the data from the GC analysis plus the internal response factor, the following calculation was performed:

$$Amount Diglycidyl Ethers = \frac{\begin{matrix}( amount internal standard ) \\ ( area diglycidyl ethers ) ( Interal Response Factor )\end{matrix}}{( area internal standard )}$$

### Comparative Example A

### Two State Synthesis of Epoxy Resin of cis-, trans-1,3- and 1,4-Cyclohexanedimethanol

Epoxidation of cis-, trans-1,3- and 1,4-cyclohexanedimethanol (UNOXOL™ Diol) was performed using two stages of aqueous sodium hydroxide addition followed by fractional vacuum distillation to separate the constituents of the epoxy resin:

A. Epoxidation Reaction

A 5 L, 4 neck, glass, round bottom reactor was charged with UNOXOL™ Diol (432.63 g, 3.0 moles, 6.0 hydroxyl eq), epichlorohydrin (1110.24 g, 12.0 moles, 2:1 epichlorohydrin:UNOXOL™ Diol hydroxyl eq ratio), toluene (2.5 L), and benzyltriethylammonium chloride (43.62 g, 0.1915 mole) in the indicated order. [UNOXOL™ cyclic dialcohol is a registered trademark of Union Carbide Corporation.] The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). [Teflon™ fluorocarbon resin is a trademark of E.I. duPont de Nemours.] A controller monitored the temperature registered on the thermometer in the reactor and provided heating via the heating mantle placed under the reactor as well as cooling delivered by a pair of fans positioned on the reactor exterior. Sodium hydroxide (360.0 g, 9.0 moles) dissolved in DI water (360 g) for the initial addition was added to a side arm vented addition funnel, sealed with a ground glass stopper, then attached to the reactor. Stirring commenced to give a 25° C. mixture followed by commencement of dropwise addition of the aqueous sodium hydroxide solution. The reaction mixture was allowed to self-heat to 40° C. during the aqueous sodium hydroxide addition time and then held at that temperature via cooling from the fans as needed. Thus, after 130 min, 42.3% of the aqueous sodium hydroxide was added causing the reaction temperature to first reach 39-40° C. and then remain at that temperature range for the remainder of the aqueous sodium hydroxide addition. Addition of the aqueous sodium hydroxide required a total of 248 min After 16 hr of postreaction the temperature had declined to 26° C., stirring ceased, and the reactor contents were allowed to settle. The organic layer was decanted from the reactor followed by addition of 1.5 L of DI water to the salt and residual toluene left behind in the reactor. After addition into a 2 L separatory funnel and settling, the toluene layer which separated from the aqueous salt solution was recovered and combined back with the decanted organic layer. The aqueous layer was discarded as waste. GC analysis after normalization to remove solvents (acetonitrile and toluene) and unreacted epichlorohydrin revealed the presence of 4.51 area % light components, 2.32 area % unreacted cis-, trans-1,3- and 1,4-cyclohexanedimethanol; 43.14 area % MGE, 0.14 area % of a pair of components associated with the DGE peaks, 45.83 area % DGE, and 4.06 area % oligomers that were volatile under the conditions of the GC analysis.

The organic layer was reloaded into the reactor along with fresh benzyltriethylammonium chloride (21.81 g, 0.1915 mole). Sodium hydroxide (180 g, 4.5 moles) dissolved in DI water (180 g) was added to a side arm vented addition funnel, sealed with a ground glass stopper, then attached to the reactor. Stirring commenced to give a 24° C. mixture followed by commencement of dropwise addition of the aqueous sodium hydroxide solution. The reaction mixture was allowed to self-heat during the aqueous sodium hydroxide addition time. Thus, after 120 min 100% of the aqueous sodium hydroxide was added causing the reaction temperature to reach a maximum of 34.5° C. After 16.2 hr of postreaction the temperature had declined to 24° C., stirring ceased, and the reactor contents allowed to settle. The organic layer was decanted from the reactor followed by addition of 1.0 L of DI water to the salt and residual toluene left behind in the reactor. After addition into a 2 L separatory funnel and settling, the toluene layer which separated from the aqueous salt solution was recovered and combined back with the decanted organic layer. The aqueous layer was discarded as waste. GC analysis after normalization to remove solvents (acetonitrile and toluene) and unreacted epichlorohydrin revealed the presence of 5.16 area % light components, 0.27 area % unreacted cis-, trans-1,3- and 1,4-cyclohexanedimethanol; 13.64 area % MGE, 0.26 area % of a pair of components associated with the DGE peaks, 73.68 area % DGE, and 6.99 area % oligomers that were volatile under the conditions of the GC analysis.

B. Epoxy Resin Product Isolation

After removal of the aqueous layer from the reaction with the second aqueous sodium hydroxide addition, the organic layer was equally split between the pair of separatory funnels and the contents of each respective separatory funnel then washed with DI water (400 mL) by vigorously shaking. The washed product was allowed to settle for 2 hr, and then the aqueous layer was removed and discarded as waste. A second wash was completed using the aforementioned method, with settling overnight (20 hr) required to fully resolve the organic and aqueous layers. The combined, hazy organic solution was filtered through a bed of anhydrous, granular sodium sulfate in a 600 mL fritted glass funnel providing a transparent filtrate.

Rotary evaporation of the filtrate using a maximum oil bath temperature of 106° C. to a final vacuum of 2.4 mm of Hg removed the bulk of the volatiles. A total of 731.45 g of light yellow colored, transparent liquid was recovered after completion of the rotary evaporation. GC analysis after normalization to remove solvent (acetonitrile) revealed the presence of 14.37 area % MGE, 0.20 area % of a pair of components associated with the DGE peaks, 81.98 area % DGE, and 3.45 area % oligomers that were volatile under the conditions of the GC analysis. Thus, GC analysis revealed that essentially all light boiling components, including residual epichlorohydrin, had been removed.

C. Fractional Vacuum Distillation

A portion (730.72 g) of the product from the rotary evaporation was added to a 1 L, 3 neck, glass, round bottom reactor equipped with magnetic stirring and a thermometer for monitoring the pot temperature. A one piece integral vacuum jacketed Vigreux distillation column and head was attached to the reactor. The distillation column nominally provided 9 to 18 theoretical plates depending on the mode of operation. The distillation head was equipped with an overhead thermometer, air cooled condenser, a receiver and a vacuum takeoff. A vacuum pump was employed along with a liquid nitrogen trap and an in-line digital thermal conductivity vacuum gauge. Stirring commenced followed by application of full vacuum then progressively increased heating using a thermostatically controlled heating mantle. A clean receiver was used to collect each respective distillation cut. During the distillation, the initial distillation cuts were taken to sequentially remove all components boiling below the cyclohexanedimethanols, all unreacted cyclohexanedimethanols, and the bulk of the MGE. GC analysis was conducted on each fraction collected from the distillation to give MGE and DGE wt %. Total amounts of MGE and DGE were used to calculate respective yields based on cis-, trans-1,3- and 1,4-cyclohexanedimethanol reactant with the results shown in Table I. The final distillation cuts sought to selectively remove DGE, leaving the oligomeric product (215.32 g) in the distillation pot. Normalization with respect to the total epoxy resin recovered from the rotary evaporation indicated 215.54 g of oligomers. GC analysis using a cyclohexanone internal standard revealed that the oligomers contained residual 5.51 wt % DGE with the balance as the oligomers. After removal of the weight contributed by the residual DGE, the normalized weight of DGE-free oligomers was 203.66 g. After normalization to remove the peaks associated with acetonitrile solvent and the DGE, the GC analysis demonstrated the following oligomeric components containing multiple isomers:

4.52 area % 2-propanol, 1-(oxiranylmethoxy)-3-[[3(or 4)-[(oxiranylmethoxy)methyl]cyclohexyl]methoxy]-
and
   oxirane, 2-[[2-chloro-1-[[[3(or 4)-[(oxiranylmethoxy)methyl]cyclohexyl]methoxy]methyl]ethoxy]methyl]-
   20.39 area % oxirane, 2-[[[3(or 4)-[[2,3-bis(oxiranylmethoxy)propoxy]methyl]cyclohexyl]methoxy]methyl]-
   1.44 area % cyclohexanemethanol, 3(or 4)-[[2-hydroxy-3-[[3(or 4)-[(oxiranylmethoxy)methyl]cyclohexyl]methoxy]propoxy]methyl]-
   22.03 area % 2-propanol, 1,3-bis[[3(or 4)-[(oxiranylmethoxy)methyl]cyclohexyl]methoxy]-
   51.62 area % oxirane, 2-[[2-[[3(or 4)-[(oxiranylmethoxy)methyl]cyclohexyl]methoxy]-1-[[[3(or 4)-[(oxiranylmethoxy)methyl]cyclohexyl]methoxy]methyl]ethoxy]methyl]-
   Titration demonstrated an EEW of 197.1. I.C.I. cone and plate viscosity was 3472 cp.

### Comparative Example B

### Two Stage Synthesis of Epoxy Resin of cis-, trans-1,3 and 1,4-Cyclohexanedimethanol with Recycle of Monoglycidyl Ether and Diglycidyl Ether of cis-, trans-1,3 and 1,4-Cyclohexanedimethanol in Stage 1

Epoxidation of cis-, trans-1,3- and 1,4-cyclohexanedimethanol (UNOXOL™ Diol) was performed using two stages of aqueous sodium hydroxide addition with recycle of MGE and DGE of cis-, trans-1,3- and 1,4-cyclohexanedimethanol in the first stage followed by fractional vacuum distillation to separate the constituents of the epoxy resin:

A. Epoxidation Reaction

A 5 L, 4 neck, glass, round bottom reactor was charged with UNOXOL™ Diol (432.63 g, 3.0 moles, 6.0 hydroxyl eq), epichlorohydrin (1110.24 g, 12.0 moles, 2:1 epichlorohydrin:UNOXOL™ Diol hydroxyl eq ratio), toluene (2.5 L), benzyltriethylammonium chloride (43.62 g, 0.1915 mole), and a recycle stream consisting of MGE of cis-, trans-1,3- and 1,4-cyclohexanedimethanol (63.42 g, 0.3167 mole) and DGE of cis-, trans-1,3- and 1,4-cyclohexanedimethanol (150.88 g, 0.5886 mole) in the indicated order. The reactor was additionally equipped as specified in Comparative Example A above. Sodium hydroxide (360.0 g, 9.0 moles) dissolved in DI water (360 g) for the initial addition was added to a side arm vented addition funnel, sealed with a ground glass stopper, then attached to the reactor. Stirring commenced to give a 22° C. mixture followed by commencement of dropwise addition of the aqueous sodium hydroxide solution. The reaction mixture was allowed to self-heat to 40° C. during the aqueous sodium hydroxide addition time and then held at that temperature via cooling from the fans as needed. Thus, after 92 min, 43.2% of the aqueous sodium hydroxide was added causing the reaction temperature to first reach 39-40° C. and then remain at that temperature range for the remainder of the aqueous sodium hydroxide addition. Addition of the aqueous sodium hydroxide required a total of 222 min. After 15.8 hr of postreaction the temperature had declined to 27.5° C., stirring ceased, and the reactor contents were allowed to settle. The organic layer was decanted from the reactor and processed as specified in Comparative Example A above. GC analysis after normalization to remove solvents (acetonitrile and toluene) and unreacted epichlorohydrin revealed the presence of 2.91 area % light components, 2.15 area % unreacted cis-, trans-1,3- and 1,4-cyclohexanedimethanol; 36.05 area % MGE, 0.17 area % of a pair of components associated with the DGE peaks, 56.34 area % DGE, and 2.38 area % oligomers that were volatile under the conditions of the GC analysis.

The organic layer was reloaded into the reactor along with fresh benzyltriethylammonium chloride (21.81 g, 0.1915 mole). Sodium hydroxide (180 g, 4.5 moles) dissolved in DI water (180 g) was added to a side arm vented addition funnel, sealed with a ground glass stopper, then attached to the reactor. Stirring commenced to give a 24° C. mixture followed by commencement of dropwise addition of the aqueous sodium hydroxide solution. The reaction mixture was allowed to self-heat during the aqueous sodium hydroxide addition time. Thus, after 135 min 100% of the aqueous sodium hydroxide was added causing the reaction temperature to reach a maximum of 34.5° C. After 16.35 hr of postreaction the temperature had declined to 24° C., stirring ceased, and the reactor contents were allowed to settle. The organic layer was decanted from the reactor and processed as specified in Comparative Example A above. GC analysis after normalization to remove solvents (acetonitrile and toluene) and unreacted epichlorohydrin revealed the presence of 6.73 area % light components, 0.29 area % unreacted cis-, trans-1,3- and 1,4-cyclohexanedimethanol; 12.95 area % MGE, 0.29 area % of a pair of components associated with the DGE peaks, 77.55 area % DGE, and 2.19 area % oligomers that were volatile under the conditions of the GC analysis.

B. Epoxy Resin Product Isolation

The aqueous layer from the reaction was processed as specified in Comparative Example A above. Rotary evaporation of the filtrate using a maximum oil bath temperature of 100° C. to a final vacuum of 2.7 mm of Hg removed the bulk of the volatiles. A total of 964.46 g of light yellow colored, transparent liquid was recovered after completion of the rotary evaporation. GC analysis after normalization to remove solvent (acetonitrile) revealed the presence of 12.58 area % MGE, 0.24 area % of a pair of components associated with the DGE peaks, 83.12 area % DGE, and 4.06 area % oligomers that were volatile under the conditions of the GC analysis. Thus, GC analysis revealed that essentially all light boiling components, including residual epichlorohydrin, had been removed.

C. Fractional Vacuum Distillation

A portion (964.27 g) of the product from the rotary evaporation was processed as specified in Comparative Example A above. The amounts of MGE and DGE after removal of the amounts of MGE and DGE charged in the recycle step were used to calculate respective yields based on cis-, trans-1,3- and 1,4-cyclohexanedimethanol reactant with the results shown in Table I. The final distillation cuts sought to selectively remove DGE, leaving the oligomeric product (283.86 g) in the distillation pot. Normalization with respect to the total epoxy resin recovered from the rotary evaporation indicated 283.92 g of oligomers. GC analysis using a cyclohexanone internal standard revealed that the oligomers contained residual 7.67 wt % DGE with the balance as the oligomers. After removal of the weight contributed by the residual DGE, the normalized weight of DGE-free oligomers was 262.14 g. After normalization to remove the peaks associated with acetonitrile solvent and the DGE, the GC analysis demonstrated the following oligomeric components containing multiple isomers:

2.97 area % 2-propanol, 1-(oxiranylmethoxy)-3-[[3(or 4)-[(oxiranylmethoxy)methyl]cyclohexyl]methoxy]-
and
   oxirane, 2-[[2-chloro-1-[[[3(or 4)-[(oxiranylmethoxy)methyl]cyclohexyl]methoxy]methyl]ethoxy]methyl]-
   18.91 area % oxirane, 2-[[[3(or 4)-[[2,3-bis(oxiranylmethoxy)propoxy]methyl]cyclohexyl]methoxy]methyl]-
   2.31 area % cyclohexanemethanol, 3(or 4)-[[2-hydroxy-3-[[3(or 4)-[(oxiranylmethoxy)methyl]cyclohexyl]methoxy]propoxy]methyl]-
   27.24 area % 2-propanol, 1,3-bis[[3(or 4)-[(oxiranylmethoxy)methyl]cyclohexyl]methoxy]-
   48.57 area % oxirane, 2-[[2-[[3(or 4)-[(oxiranylmethoxy)methyl]cyclohexyl]methoxy]-1-[[[3(or 4)-[(oxiranylmethoxy)methyl]cyclohexyl]methoxy]methyl]ethoxy]methyl]-
   Titration demonstrated an EEW of 198.1. I.C.I. cone and plate viscosity was 3316 cp.

### Example 1

### Two State Epoxidation of cis-, trans-1,3 and 1,4-Cyclohexanedimethanol and Mixture of Monoglycidyl Ether and Diglycidyl Ether of 1,3-Dihydroxy-2,2-Dimethylpropane

Epoxidation of cis-, trans-1,3- and 1,4-cyclohexanedimethanol (UNOXOL™ Diol) was performed using two stages of aqueous sodium hydroxide addition with addition of MGE and DGE of 1,3-dihydroxy-2,2-dimethylpropane in the first stage followed by fractional vacuum distillation to separate the constituents of the epoxy resin:

A. Epoxidation Reaction

A 5 L, 4 neck, glass, round bottom reactor was charged with UNOXOL™ Diol (432.63 g, 3.0 moles, 6.0 hydroxyl eq), epichlorohydrin (1110.24 g, 12.0 moles, 2:1 epichlorohydrin:UNOXOL™ Diol hydroxyl eq ratio), toluene (2.5 L), benzyltriethylammonium chloride (43.62 g, 0.1915 mole), and a mixture of MGE of 1,3-dihydroxy-2,2-dimethylpropane (27.46 g, 0.1714 mole) and DGE of 1,3-dihydroxy-2,2-dimethylpropane (95.08 g, 0.4396 mole) in the indicated order. The reactor was additionally equipped as specified in Comparative Example A above. Sodium hydroxide (360.0 g, 9.0 moles) dissolved in DI water (360 g) for the initial addition was added to a side arm vented addition funnel, sealed with a ground glass stopper, then attached to the reactor. Stirring commenced to give a 22° C. mixture followed by commencement of dropwise addition of the aqueous sodium hydroxide solution. The reaction mixture was allowed to self-heat during the aqueous sodium hydroxide addition time to a limit of 40° C. and then held at that temperature, if achieved, via cooling from the fans as needed. Thus, after 232 min, 100% of the aqueous sodium hydroxide was added causing the reaction temperature to reach 37° C. A sample was taken for GC analysis one hour after completion of the aqueous sodium hydroxide addition. After normalization to remove solvents (acetonitrile and toluene) and unreacted epichlorohydrin the GC analysis revealed the presence of 4.57 area % light components, 2.97 area % MGE of 1,3-dihydroxy-2,2-dimethylpropane; 8.68 area % unreacted cis-, trans-1,3- and 1,4-cyclohexanedimethanol; 10.14 area % DGE of 1,3-dihydroxy-2,2-dimethylpropane; 0.13 area % of a pair of peaks associated with the MGE of cis-, trans-1,3- and 1,4-cyclohexanedimethanol; 43.39 area % MGE of cis-, trans-1,3- and 1,4-cyclohexanedimethanol; 0.34 area % of a pair of peaks associated with the DGE of cis-, trans-1,3- and 1,4-cyclohexanedimethanol; 20.32 area % DGE of cis-, trans-1,3- and 1,4-cyclohexanedimethanol, and 9.44 area % oligomers that were volatile under the conditions of the GC analysis. After 16.05 hr of postreaction the temperature had declined to 29° C., stirring ceased, and the reactor contents were allowed to settle. The organic layer was decanted from the reactor and processed as specified in Comparative Example A above. GC analysis after normalization to remove solvents (acetonitrile and toluene) and unreacted epichlorohydrin revealed the presence of 3.57 area % light components, 2.17 area % MGE of 1,3-dihydroxy-2,2-dimethylpropane; 3.00 area % unreacted cis-, trans-1,3- and 1,4-cyclohexanedimethanol; 9.93 area % DGE of 1,3-dihydroxy-2,2-dimethylpropane; 0.28 area % of a pair of peaks associated with the MGE of cis-, trans-1,3- and 1,4-cyclohexanedimethanol; 35.89 area % MGE of cis-, trans-1,3- and 1,4-cyclohexanedimethanol; 0.19 area % of a pair of peaks associated with the DGE of cis-, trans-1,3- and 1,4-cyclohexanedimethanol; 32.25 area % DGE of cis-, trans-1,3- and 1,4-cyclohexanedimethanol, and 12.71 area % oligomers that were volatile under the conditions of the GC analysis.

The organic layer was reloaded into the reactor along with fresh benzyltriethylammonium chloride (21.81 g, 0.1915 mole). Sodium hydroxide (180 g, 4.5 moles) dissolved in DI water (180 g) was added to a side arm vented addition funnel, sealed with a ground glass stopper, then attached to the reactor. Stirring commenced to give a 22.5° C. mixture followed by commencement of dropwise addition of the aqueous sodium hydroxide solution. The reaction mixture was allowed to self-heat during the aqueous sodium hydroxide addition time. Thus, after 89 min 73.8% of the aqueous sodium hydroxide was added causing the reaction temperature to reach a maximum of 31° C. and then remain at that temperature range for the remainder of the aqueous sodium hydroxide addition. Addition of the aqueous sodium hydroxide required a total of 125 min After 16.95 hr of postreaction the temperature had declined to 22° C., stirring ceased, and the reactor contents were allowed to settle. The organic layer was decanted from the reactor and processed as specified in Comparative Example A above. GC analysis after normalization to remove solvents (acetonitrile and toluene) and unreacted epichlorohydrin revealed the presence of 2.45 area % light components, 1.40 area % MGE of 1,3-dihydroxy-2,2-dimethylpropane; 0.30 area % unreacted cis-, trans-1,3- and 1,4-cyclohexanedimethanol; 9.54 area % DGE of 1,3-dihydroxy-2,2-dimethylpropane; 0.29 area % of a pair of peaks associated with the MGE of cis-, trans-1,3- and 1,4-cyclohexanedimethanol; 12.95 area % MGE of cis-, trans-1,3- and 1,4-cyclohexanedimethanol; 0.18 area % of a pair of peaks associated with the DGE of cis-, trans-1,3- and 1,4-cyclohexanedimethanol; 55.43 area % DGE of cis-, trans-1,3- and 1,4-cyclohexanedimethanol, and 17.46 area % oligomers that were volatile under the conditions of the GC analysis.

B. Epoxy Resin Product Isolation

The aqueous layer from the reaction was processed as specified in Comparative Example A above. Rotary evaporation of the filtrate using a maximum oil bath temperature of 100° C. to a final vacuum of 3.3 mm of Hg removed the bulk of the volatiles. A total of 843.73 g of pale yellow colored, transparent liquid was recovered after completion of the rotary evaporation. GC analysis after normalization to remove solvent (acetonitrile) revealed the presence of 0.26 area % light components, 0.31 area % MGE of 1,3-dihydroxy-2,2-dimethylpropane; 0.07 area % unreacted cis-, trans-1,3- and 1,4-cyclohexanedimethanol; 9.41 area % DGE of 1,3-dihydroxy-2,2-dimethylpropane; 0.31 area % of a pair of peaks associated with the MGE of cis-, trans-1,3- and 1,4-cyclohexanedimethanol; 12.25 area % MGE of cis-, trans-1,3- and 1,4-cyclohexanedimethanol; 0.22 area % of a pair of peaks associated with the DGE of cis-, trans-1,3- and 1,4-cyclohexanedimethanol; 56.83 area % DGE of cis-, trans-1,3- and 1,4-cyclohexanedimethanol, and 20.34 area % oligomers that were volatile under the conditions of the GC analysis. Thus, GC analysis revealed that the light boiling components, including all residual epichlorohydrin, had been substantially removed.

C. Fractional Vacuum Distillation

A portion (843.02 g) of the product from the rotary evaporation was processed as specified in Comparative Example A above. The final distillation cuts sought to selectively remove DGE of cis-, trans-1,3- and 1,4-cyclohexanedimethanol, leaving the oligomeric product (252.72 g) in the distillation pot. Normalization with respect to the total epoxy resin recovered from the rotary evaporation indicated 252.93 g of oligomers. GC analysis using a cyclohexanone internal standard revealed that the oligomers contained residual 4.52 wt % DGE of cis-, trans-1,3- and 1,4-cyclohexanedimethanol with the balance as the oligomers. After removal of the weight contributed by the residual DGE, the normalized weight of DGE-free oligomers was 241.50 g (Table I).

A total of 7.43 grams of unreacted MGE of 1,3-dihydroxy-2,2-dimethylpropane was removed in the distillation cuts thus demonstrating incorporation of 20.03 grams of the MGE into the oligomer product, as well as possible conversion of some of this MGE into the corresponding DGE. A total of 83.60 grams of unreacted DGE of 1,3-dihydroxy-2,2-dimethylpropane was removed in the distillation cuts. Therefore at least 11.48 grams of the DGE of 1,3-dihydroxy-2,2-dimethylpropane was incorporated into the oligomer product, with additional DGE derived from any in situ epoxidation of MGE to DGE also possibly incorporated into the oligomer product.

The final distillation cuts also sought to selectively remove DGE of cis-, trans-1,3- and 1,4-cyclohexanedimethanol free of any MGE or DGE of 1,3-dihydroxy-2,2-dimethylpropane. Thus the final three distillation cuts were combined to provide 303.34 grams of a product comprising 98.94% wt DGE of cis-, trans-1,3- and 1,4-cyclohexanedimethanol; 0.84% wt MGE of cis-, trans-1,3- and 1,4-cyclohexanedimethanol; with the balance as two minor component associated with the DGE of cis-, trans-1,3- and 1,4-cyclohexanedimethanol; and no detectable MGE or DGE of 1,3-dihydroxy-2,2-dimethylpropane.

After normalization to remove the peaks associated with acetonitrile solvent and the DGE of cis-, trans-1,3- and 1,4-cyclohexanedimethanol, the GC analysis demonstrated the following oligomeric components containing multiple isomers:

### 3.93 Area % in 23.13-30.40 Min Retention Time Region, Includes:

new hybrid oligomer components
and
   2-propanol, 1-(oxiranylmethoxy)-3-[[3(or 4)-[(oxiranylmethoxy)methyl]cyclohexyl]methoxy]-
and
   oxirane, 2-[[2-chloro-1-[[[3(or 4)-[(oxiranylmethoxy)methyl]cyclohexyl]methoxy]methyl]ethoxy]methyl]-

### 0.25 Area % in 31.59-31.95 Min Retention Time Region:

new hybrid oligomer components

### 22.66 Area % in 32.59-37.98 Min Retention Time Region:

oxirane, 2-[[[3(or 4)[[2,3-bis(oxiranylmethoxy)propoxy]methyl]cyclohexyl]methoxy]methyl]-

### 0.24 Area % in 38.80-39.99 Min Retention Time Region:

cyclohexanemethanol, 3(or 4)-[[2-hydroxy-3-[[3(or 4)-[(oxiranylmethoxy)methyl]cyclohexyl]methoxy]propoxy]methyl]-

### 11.43 Area % in 40.44-47.30 Min Retention Time Region:

new hybrid oligomer components

### 18.98 Area % in 52.59-64.00 Min Retention Time:

2-propanol, 1,3-bis[[3(or 4)-[(oxiranylmethoxy)methyl]cyclohexyl]methoxy]-

### 36.94 Area % in 73.86-93.31 Min Retention Time:

oxirane, 2-[[2-[[3(or 4)-[(oxiranylmethoxy)methyl]cyclohexyl]methoxy]-1-[[[3(or 4)-[(oxiranylmethoxy)methyl]cyclohexyl]methoxy]methyl]ethoxy]methyl]-

The aforementioned 23.13-30.40 min retention time region included 4 specific clusters of peaks with the following retention time ranges: (1) 23.13-24.01 min, (2) 24.19-25.11 min, (3) 25.47-26.93 min, (4) 27.85-30.40 min As a reference point, the four isomeric DGEs eluted at 22.45-23.12 min Titration demonstrated an EEW of 201.3. I.C.I. cone and plate viscosity was 3436 cp.

D. Mass Spectrometric (MS) Analysis using Potassium Ionization of Desorbed Species (K⁺IDS)

The ionization technique used K⁺IDS MS analysis provides a “parent ion” in the form of [M+K]⁺ when a sample is placed on a K⁺ emitting matrix of a direct exposure probe (DEP) filament and heated very rapidly inside a MS ionization source.

The K⁺IDS MS analysis was performed using a Finnigan SSQ 7000 mass spectrometer. The K⁺ emitting matrix on the DEP was prepared by depositing a drop from a slurry of potassium nitrate (1.02 g), aluminum oxide (0.5 g) and silicon dioxide (0.6 g) in acetone on the DEP filament. After allowing the slurry to dry, the DEP was inserted into the MS ionization source and rapidly heated using a filament current of 800 mA until the production of K⁺ reached a steady state. This indicated complete formation of a “thermionic K⁺ glass” bead (potassium aluminosilicate matrix). The following sequence and conditions were employed for the analysis: (a) deposit a 1 μL sample on the filament bead and insert the probe back into the MS, (b) leave MS filament off during the K⁺IDS MS analysis, (c) set the multiplier voltage to 1800 V, (d) start data acquisition, and in the DEP instrument control window use the command (“s800”) for rapid K⁺ generation and sample vaporization. Potassium ionization MS were acquired on the desorbed components at one-second intervals for component identification. The mass spectrometer was scanned from 135-1150 amu to observe potassium attached ions. The following possible structures (note: possible isomers are not indicated) were postulated based on the analysis of a sample of the oligomer (pot product) from C. above. The relative abundance and amu after removal of 39 amu for potassium are additionally given:

5.22 relative abundance, 256 amu, DGE
4.49 relative abundance, 330 amu, 2-propanol, 1-(oxiranylmethoxy)-3-[[3(or 4)-[(oxiranylmethoxy)methyl]cyclohexyl]methoxy]-
25.35 relative abundance, 386 amu, oxirane, 2-[[[3(or 4)-[[2,3-bis(oxiranylmethoxy)propoxy]methyl]cyclohexyl]methoxy]methyl]-
4.53 relative abundance, 400 amu, cyclohexanemethanol, 3(or 4)-[[2-hydroxy-3-[[3(or 4)-[(oxiranylmethoxy)methyl]cyclohexyl]methoxy]propoxy]methyl]-
17.51 relative abundance, 416 amu, new hybrid oligomer components:

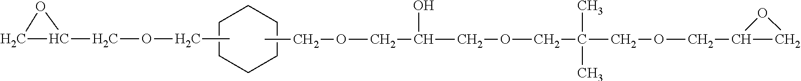

57.92 relative abundance, 456 amu, 2-propanol, 1,3-bis[[3(or 4)-[(oxiranylmethoxy)methyl]cyclohexyl]methoxy]-
20.97 relative abundance, 472 amu, new hybrid oligomer components:

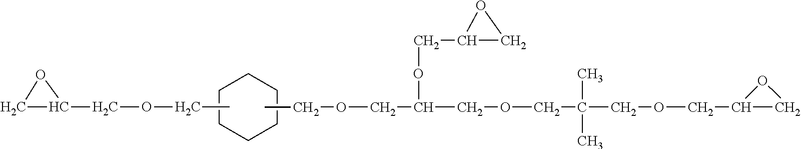

100 relative abundance, 512 amu, oxirane, 2-[[2-[[3(or 4)-[(oxiranylmethoxy)methyl]cyclohexyl]methoxy]-1-[[[3(or 4)-[(oxiranylmethoxy)methyl]cyclohexyl]methoxy]methyl]ethoxy]methyl]-
22.46 relative abundance, 586 amu:

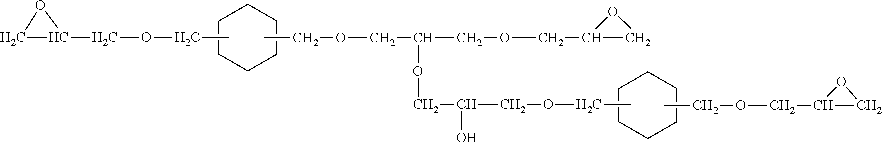

31.17 relative abundance, 642 amu:
reaction product of:

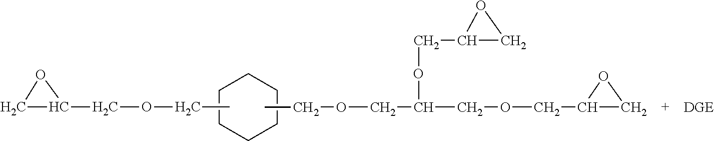

11.15 relative abundance, 656 amu:

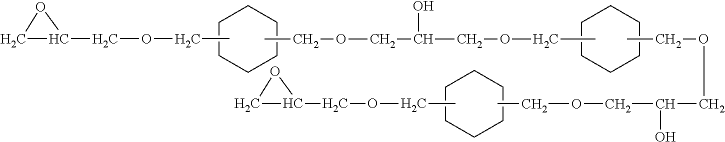

26.18 relative abundance, 672 amu, new hybrid oligomer components:

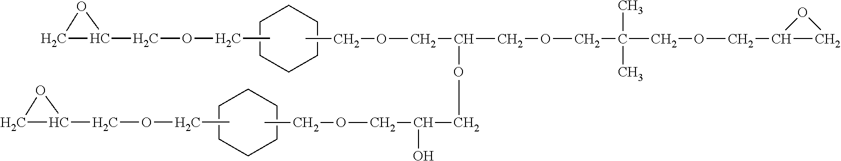

33.9 relative abundance, 712 amu:

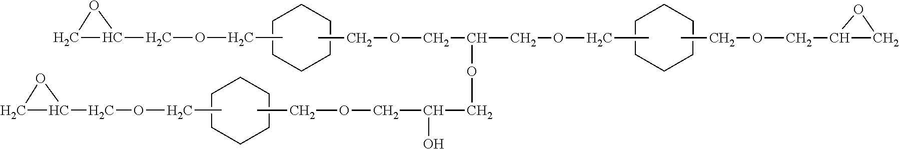

13.42 relative abundance, 728 amu, new hybrid oligomer components:

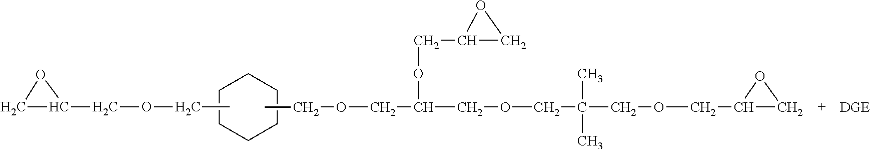

15.01 relative abundance, 768 amu:
reaction product of

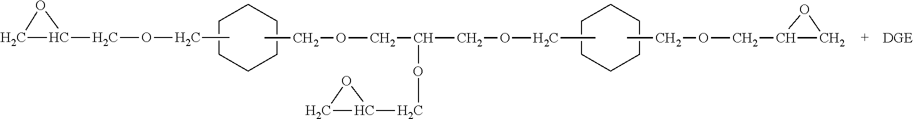

Minor amounts of components of higher amu are also indicated by the MS analysis.

Comparison of the data given in Table I demonstrates the effect of added MGE and DGE of 1,3-dihydroxy-2,2-dimethylpropane into the epoxidation of cis-, trans-1,3- and 1,4-cyclohexanedimethanol. Specifically, conversion of cis-, trans-1,3- and 1,4-cyclohexanedimethanol and combined yield of MGE/DGE are very similar to the 2 stage epoxidation (Comparative Example A) while maintaining comparable other parameters such as EEW and viscosity. Furthermore, the results in Example 1 demonstrate the ability of the distillation process to (1) recover unreacted MGE or DGE of 1,3-dihydroxy-2,2-dimethylpropane for use in another reaction and to (2) recover a substantial amount of DGE of cis-, trans-1,3- and 1,4-cyclohexanedimethanol product free of any MGE or DGE of 1,3-dihydroxy-2,2-dimethylpropane.

TABLE I

| | | | Comparative |
|---|---|---|---|
| | Example 1 | | Example B |
| | (2-Stage | Comparative | (2-Stage |
| | Epoxidation with | Example A | Epoxidation with |
| | Added MGE/ | (2-Stage | MGE/DGE |
| PROPERTY | DGE) | Epoxidation) | Recycle) |
| Conversion (%) | 99.9 | >99.95 | >99.95 |
| MGE Yield (%) | 15.6 | 11.7 | 5.1 |
| DGE Yield (%) | 54.4 | 58.6 | 59.0 |
| Combined | 70.0 | 70.3 | 64.1 |
| MGE/DGE | | | |
| Yield (%) | | | |
| DGE Residual | 4.52 | 5.51 | 7.67 |
| in Pot (% wt.) | | | |
| Pot Less Residual | 241.50 | 203.66 | 262.14 |
| DGE (g) | | | |
| EEW Pot | 201.3 | 197.1 | 198.1 |
| I.C.I. Cone and | 3436 | 3316 | 3472 |
| Plate Viscosity | | | |
| Pot (cp/25° C.) | | | |

### Example 2

### Preparation and Curing of a Thermosettable Blend of H-PACE Resin and Diethylenetriamine

A portion (10.0302 g, 0.04984 epoxide eq) of the H-PACE resin (distillation bottoms) from Example 1 and DETA (1.0284 g, 0.04985 N—H eq) were added to a glass bottle and vigorously stirred together (a scale with four place accuracy was used for weighing) A portion (12.5 mg) of the homogeneous solution was removed for DSC analysis. An exotherm attributed to curing was observed with a 47.7° C. onset, 110.1° C. maximum, and a 206.4° C. endpoint accompanied by an enthalpy of 416.6 J/g. The cured product recovered from the DSC analysis was a transparent, light yellow colored, rigid solid.

### Example 3

### Preparation of Clear, Unfilled Casting of a Thermosettable Blend of the H-PACE Resin and Diethylenetriamine and Analysis of Glass Transition Temperature

The remaining portion of the H-PACE resin (distillation bottoms) and DETA blend from Example 2 was added to an aluminum dish and cured in an oven using the following schedule: 1 hr at 70° C., 1 hr at 100° C., 1 hr at 125° C., and 1 hr at 150° C. A portion (33.9 mg) of the transparent, light yellow colored casting was removed for DSC analysis. A Tg of 51° C. was observed, with no indication of further curing or exothermic decomposition observed up to the 250° C. DSC analysis temperature. A second scanning using the aforementioned conditions again revealed a 53° C. Tg.

### Example 4

### Re-Epoxidization of H-PACE Resin

Re-epoxidation of the H-PACE resin (Example 1) was performed using two stages of aqueous sodium hydroxide addition:

A. Re-Epoxidation Reaction

A 5 L, 4 neck, glass, round bottom reactor was charged with hybrid polyfunctional aliphatic cycloaliphatic oligomer product (150.48 g), epichlorohydrin (167.2 g, 1.806 moles), toluene (602 mL) and benzyltriethylammonium chloride (6.57 g, 0.02885 mole). The reactor was additionally equipped as specified in Example 1 above. The hybrid polyfunctional aliphatic cycloaliphatic oligomer product used came from Example 1 C. Sodium hydroxide (54.2 g, 1.355 moles) dissolved in DI water (54.2 g) for the initial addition was added to a side arm vented addition funnel, sealed with a ground glass stopper, then attached to the reactor. Stirring commenced to give a 24° C. mixture followed by commencement of dropwise addition of the aqueous sodium hydroxide solution. The reaction mixture was allowed to self-heat during the aqueous sodium hydroxide addition. Thus, after 61 min the reaction temperature first reached 25.5° C. and the addition of the aqueous sodium hydroxide was completed Immediately after completion of the aqueous sodium hydroxide addition, heating commenced to bring the reaction to 40° C. after 24 min of heating. After 20.45 hr of postreaction at 40° C., stirring ceased, and the reactor contents were allowed to settle. The organic layer was decanted from the reactor and processed as specified in Example 1 with a decrease in DI water used to 250 mL.

The organic layer was reloaded into the reactor along with fresh benzyltriethylammonium chloride (6.57 g, 0.02885 mole). Sodium hydroxide (54.2 g, 1.355 moles) dissolved in DI water (54.2 g) was added to a side arm vented addition funnel, sealed with a ground glass stopper, then attached to the reactor. Stirring commenced to give a 25° C. mixture followed by commencement of dropwise addition of the aqueous sodium hydroxide solution. The reaction mixture was allowed to self-heat during the aqueous sodium hydroxide addition time. Thus, after 14 min the reaction temperature first reached 26° C. and then remained at 26° C. for the remainder of the aqueous sodium hydroxide addition. Addition of the aqueous sodium hydroxide required a total of 62 min Immediately after completion of the aqueous sodium hydroxide addition, heating commenced to bring the reaction to 40° C. after 36 min of heating. After 16.53 hr of postreaction at 40° C., stirring ceased, and the reactor contents were allowed to settle. The organic layer was decanted from the reactor and processed as specified in Example 1 with a decrease in DI water used to 250 mL.

B. Epoxy Resin Product Isolation

The organic layer from the reaction was processed as specified in Example 1 with a decrease in the DI water washes used to 250 mL. Rotary evaporation of the filtrate using a maximum oil bath temperature of 125° C. to a final vacuum of 4.7 mm of Hg removed the bulk of the volatiles. The product was held at 24° C. and then gravity filtered through paper. A total of 150.14 g of yellow colored, transparent liquid was recovered after completion of the filtration (note: product loss on the filter paper was not measured). After normalization to remove the peaks associated with acetonitrile solvent and the DGE of cis-, trans-1,3- and 1,4-cyclohexanedimethanol, the GC analysis demonstrated the following oligomeric components containing multiple isomers:

### 5.83 Area % in 24.79-29.79 Min Retention Time Region, Includes:

new hybrid oligomer components
and
   2-propanol, 1-(oxiranylmethoxy)-3-[[3(or 4)-[(oxiranylmethoxy)methyl]cyclohexyl]methoxy]-
and
   oxirane, 2-[[2-chloro-1-[[[3(or 4)-[(oxiranylmethoxy)methyl]cyclohexyl]methoxy]methyl]ethoxy]methyl]-

### 0.32 Area % in 30.94-31.33 Min Retention Time Region:

new hybrid oligomer components

### 18.06 Area % in 31.97-37.28 Min Retention Time Region, Includes:

oxirane, 2-[[[3(or 4)[[2,3-bis(oxiranylmethoxy)propoxy]methyl]cyclohexyl]methoxy]methyl]-

### 15.71 Area % in 41.64-46.77 Min Retention Time Region:

new hybrid oligomer components

### 4.43 Area % in 52.09-63.49 Min Retention Time Includes:

2-propanol, 1,3-bis[[3(or 4)-[(oxiranylmethoxy)methyl]cyclohexyl]methoxy]-

### 55.65 Area % in 73.49-92.71 Min Retention Time Includes:

oxirane, 2-[[2-[[3(or 4)-[(oxiranylmethoxy)methyl]cyclohexyl]methoxy]-1-[[[3(or 4)-[(oxiranylmethoxy)methyl]cyclohexyl]methoxy]methyl]ethoxy]methyl]-

The aforementioned 24.79-29.79 min retention time region included 2 specific clusters of peaks with the following retention time ranges: (1) 24.79-26.39 min, (2) 27.03-29.79 min As a reference point, the four isomeric DGEs eluted at 22.10-22.68 min Titration demonstrated an EEW of 181.11. I.C.I. cone and plate viscosity was 2885 cp.

### Example 5

### Preparation and Curing of a Thermosettable Blend of Re-Epoxidized H-PACE Resin and Diethylenetriamine

A portion (10.0151 g, 0.0553 epoxide eq) of the re-epoxidized H-PACE resin from Example 4 and DETA (1.1410 g, 0.0553 N—H eq) were added to a glass bottle and vigorously stirred together (a scale with four place accuracy was used for weighing) A portion (11.3 mg) of the homogeneous solution was removed for DSC analysis. An exotherm attributed to curing was observed with a 40.8° C. onset, 121.2° C. maximum, and a 206.7° C. endpoint accompanied by an enthalpy of 500.5 J/g. The cured product recovered from the DSC analysis was a transparent, light yellow colored, rigid solid.

### Example 6

### Preparation of Clear, Unfilled Casting of a Thermosettable Blend of the Re-Epoxidized H-PACE Resin and Diethylenetriamine and Analysis of Glass Transition Temperature

The remaining portion of the re-epoxidized H-PACE resin and DETA blend from Example 4 was added to an aluminum dish and cured in an oven using the following schedule: 1 hr at 70° C., 1 hr at 100° C., 1 hr at 125° C., and 1 hr at 150° C. A portion (32.1 mg) of the transparent, light yellow colored casting was removed for DSC analysis. A Tg of 64° C. was observed, with no indication of further curing or exothermic decomposition observed up to the 250° C. DSC analysis temperature. Second and third scannings using the aforementioned conditions again both revealed a 64° C. Tg.

### Example 7

### Dynamic Mechanical Thermal Analysis (DMTA) of H-PACE Resin Cured with Diethylenetriamine

A portion (18.6595 g, 0.09272 epoxide eq) of the H-PACE resin (distillation bottoms) from Example 1 and DETA (1.9131 g, 0.09272 N—H eq) were added to a glass bottle and vigorously stirred together (a scale with four place accuracy was used for weighing) The resultant solution was B-staged by heating to 75° C. for 3 minutes continued stiffing. The B-staged solution was poured into an aluminum mold and cured in an oven using the following schedule: 1 hr at 70° C., 1 hr at 100° C., 1 hr at 125° C., and 1 hr at 150° C. A portion (1.75 by 0.5 by 0.16 inch) of the casting was subjected to DMTA in the torsional analysis mode using an Ares-LS Rheometer equipped with an ARES Environmental Controlled Oven and ARES LN₂ dewar. A 3° C. per minute rate of heating was employed with a temperature range of 25° C. to 200° C. Data was collected from a second testing of the sample. Storage modulus (G′) and tan delta values thus determined are given in Table II as a function of selected temperatures and accompanying times. The temperature observed for the tan delta transition at peak was 57.16° C.

TABLE II

| Temperature | Time | G′ × 10⁸ | |
|---|---|---|---|
| (° C.) | (min) | (Pa) | Tan delta |
| 24.89 | 0.283 | 9.14 | 0.0412 |
| 30.33 | 1.283 | 8.93 | 0.0441 |
| 35.31 | 2.267 | 8.52 | 0.0530 |
| 39.69 | 3.133 | 7.95 | 0.0697 |
| 42.63 | 3.717 | 7.40 | 0.0888 |
| 44.58 | 4 | 6.95 | 0.1061 |
| 46.11 | 4.283 | 6.26 | 0.1333 |
| 47.39 | 4.55 | 5.44 | 0.1725 |
| 48.10 | 4.7 | 4.97 | 0.1979 |
| 49.58 | 5 | 3.97 | 0.2681 |
| 50.95 | 5.283 | 3.00 | 0.3659 |
| 52.52 | 5.55 | 2.11 | 0.4947 |
| 54.30 | 5.97 | 1.01 | 0.7672 |
| 57.16 | 6.55 | 0.353 | 0.9831 |
| 58.51 | 6.82 | 0.243 | 0.8914 |
| 59.87 | 7.1 | 0.188 | 0.7309 |
| 60.64 | 7.25 | 0.170 | 0.6500 |
| 65.84 | 8.1 | 0.125 | 0.2884 |
| 70.35 | 9.2 | 0.112 | 0.0862 |
| 75.97 | 10.33 | 0.114 | 0.0299 |
| 80.90 | 11.32 | 0.116 | 0.0129 |
| 90.03 | 13.15 | 0.122 | 0.0038 |
| 149.68 | 25.08 | 0.159 | 0.0118 |
| 175.57 | 30.27 | 0.175 | 0.0022 |
| 200.13 | 35.17 | 0.189 | 0.0031 |

### Comparative Example C

### DMTA of PACE Resin Cured with Diethylenetriamine

A portion (23.9733 g, 0.1217 epoxide eq) of PACE resin (distillation bottoms) from Comparative Example A and DETA (2.5103 g, 0.1217 N—H eq) were combined, B-staged and cured using the method of Example 7. A portion (1.75 by 0.5 by 0.18 inch) of the casting was subjected to DMTA using the method of Example 7. Storage modulus (G′) and tan delta values thus determined are given in Table III as a function of selected temperatures and accompanying times. The temperature observed for the tan delta transition at peak was 59.60° C.

TABLE III

| Temperature | Time | G′ × 10⁸ | |
|---|---|---|---|
| (° C.) | (min) | (Pa) | Tan delta |
| 25.74 | 0.283 | 4.39 | 0.0299 |
| 31.35 | 1.283 | 4.28 | 0.0313 |
| 36.11 | 2.25 | 4.07 | 0.0396 |
| 40.32 | 3.1 | 3.79 | 0.0557 |
| 43.20 | 3.683 | 3.53 | 0.0756 |
| 45.27 | 4.1 | 3.28 | 0.0993 |
| 46.78 | 4.4 | 3.06 | 0.1223 |
| 47.43 | 4.53 | 2.94 | 0.1360 |
| 48.09 | 4.7 | 4.67 | 0.1525 |
| 50.33 | 5.12 | 2.31 | 0.2223 |
| 51.12 | 5.27 | 2.10 | 0.2564 |
| 52.50 | 5.55 | 1.67 | 0.3388 |
| 54.61 | 5.98 | 1.01 | 0.5159 |
| 56.78 | 6.41 | 0.501 | 0.7543 |
| 58.24 | 6.7 | 0.303 | 0.8900 |
| 59.60 | 6.98 | 0.194 | 0.9364 |
| 60.27 | 7.12 | 0.158 | 0.9210 |
| 61.00 | 7.27 | 0.133 | 0.8918 |
| 65.95 | 8.25 | 0.066 | 0.2884 |
| 70.03 | 9.23 | 0.059 | 0.1814 |
| 75.69 | 10.22 | 0.057 | 0.0511 |
| 81.25 | 11.33 | 0.058 | 0.0123 |
| 90.26 | 13.15 | 0.060 | −0.0018 |
| 149.59 | 25.02 | 0.079 | −0.0038 |
| 175.66 | 30.22 | 0.087 | −0.00095 |
| 199.37 | 34.98 | 0.095 | −0.0075 |

### Example 8

### Tensile Testing of H-PACE Resin Cured with Diethylenetriamine

A portion of the casting of H-PACE resin cured DETA from Example 7 was tested using AS™ D638 (Type V) on an Instron 4505. A modulus of 276.624 MPa was obtained. Elongation at break was 70.12%. A slight necking behavior was observed in the stress strain curve.

### Comparative Example C

### Tensile Testing of PACE Resin Cured with Diethylenetriamine

A portion of the casting of PACE resin from Comparative Example B was tested using AS™ D638 (Type V) on an Instron 4505. A modulus of 259.123 MPa was obtained. Elongation at break was 50.36%.

### Comparative Example D

### Analysis of Oligomer Structure Produced from Epoxidation of cis-, trans-1,4-Cyclohexanedimethanol Using Lewis Acid Catalyzed Coupling

Structures proposed from GC-MS analysis of a sample of a commercial grade of an epoxy resin of cis-, trans-1,4-cyclohexanedimethanol (Erisys™ GE-22S) produced via epoxidation which employed Lewis acid catalyzed coupling are given, as follows:

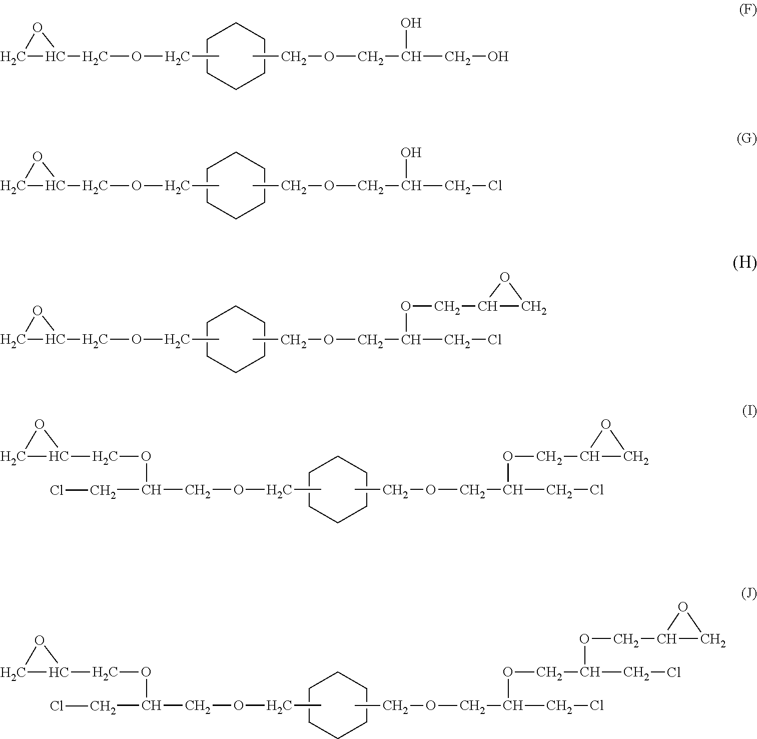

DGE designated as H is the major product, comprising >80 area % of the combined oligomer product, F-J. There are no oligomer components in common with those of the oligomers components from the quaternary ammonium halide catalyzed route, for example as shown in Comparative Examples A and B and Examples 1 and 4. Unlike the product produced from the quaternary ammonium halide catalyzed route, the product from the Lewis acid catalyzed route cannot be designated as “polyfunctional”, since the highest functionality components are only diglycidyl ethers. Component G, a monoglycidyl ether monochlorohydrin, indicates that further treatment with aqueous sodium hydroxide is needed to complete the dehydrochlorination step in the epoxidation. Notably, components H-J all possess chlorine bound in the form of chloromethyl groups. The presence of this bound chloride most likely would preclude the use of this oligomer product for many applications including electronics and coatings used in contact with food.

It will be apparent to persons skilled in the art that certain changes may be made in the methods described above without departing from the scope of the present invention. It is therefore intended that all matter herein disclosed be interpreted as illustrative only and not as limiting the scope of protection sought. Moreover, the process of the present invention is not to be limited by the specific examples set forth above including the tables to which they refer. Rather, these examples and the tables they refer to are illustrative of the process of the present invention.

1. A hybrid polyfunctional aliphatic and/or cycloaliphatic epoxy (H-PACE) resin composition comprising:
(a) a moiety selected from the group consisting of an aliphatic moiety, a cycloaliphatic moiety, and combinations thereof provided by the polyfunctional aliphatic and/or cycloaliphatic epoxy (PACE) resin; and
(b) a moiety selected from the group consisting of an aliphatic moiety, a cycloaliphatic moiety, and combinations thereof, wherein said moiety is not provided by the PACE resin.

2. A H-PACE resin composition of claim 1 comprising a reaction product of:
(a) a hydroxyl-containing material selected from the group consisting of an aliphatic hydroxyl-containing material, a cycloaliphatic hydroxyl-containing material, and combinations thereof;
(b) a material selected from the group consisting of a monoglycidyl ether containing material, a diglycidyl ether containing material, and combinations thereof;
(c) an epihalohydrin;
(d) a basic acting substance;
(e) a non-Lewis acid catalyst; and
(f) optionally, a solvent,
wherein (b) is prepared from a different precursor than (a).

3. A H-PACE resin composition of claim 2 wherein the H-PACE resin composition is subjected to a fractionation process such that said H-PACE resin composition comprises no more that 50% by weight of said hydroxyl-containing material (a).

4. A H-PACE resin product of claim 3 which contains less than 50% by weight of fully epoxidized hydroxyl-containing material (a).

5. A re-epoxidized H-PACE resin product of claim 3 comprising a reaction product of:
(a) a H-PACE resin,
(c) an epihalohydrin,
(d) a basic acting substance,
(e) a non-Lewis acid catalyst, and, optionally,
(f) a solvent.

6. A re-epoxidized H-PACE resin product of claim 4.

7. A thermosettable epoxy resin composition comprising a blend of:
(a) the H-PACE resin of claim 3;
(b) one or more epoxy resin curing agents; and
(c) optionally, one or more curing catalysts for curing epoxy resins.

8. The thermosettable epoxy resin composition of claim 7, including one or more (d) epoxy resins other than the H-PACE resin.

9. A B-staged thermoset product comprising the partially cured thermosettable epoxy resin composition of claim 7.

10. A totally cured thermoset product comprising the totally cured thermosettable epoxy resin composition of claim 7.

11. A B-staged thermoset product comprising the partially cured thermosettable epoxy resin composition of claim 8.

12. A totally cured thermoset product comprising the totally cured thermosettable epoxy resin composition of claim 8.

13. A process for preparing the composition of claim 1 comprising the steps of: (I) reacting
(a) a hydroxyl-containing material selected from the group consisting of an aliphatic hydroxyl-containing material, a cycloaliphatic hydroxyl-containing material, and combinations thereof;
(b) a material selected from the group consisting of a monoglycidyl ether containing material, a diglycidyl ether containing material, and combinations thereof prepared from an aliphatic or cycloaliphatic hydroxyl-containing material different from the material of (a);
(c) an epihalohydrin,
(d) a basic acting substance,
(e) a non-Lewis acid catalyst, and
(f) optionally, a solvent.

14. An article made from the composition of claim 7.

15. An article made from the composition of claim 8.

16. A process for preparing the composition of claim 5 comprising the steps of: (I) reacting
(a) at least one H-PACE resin,
(b) an epihalohydrin,
(c) a basic acting substance,
(d) a non-Lewis acid catalyst, and
(e) optionally, a solvent.

17. The thermosettable epoxy resin composition of claim 7 wherein the H-PACE resin (a) is a re-epoxidized H-PACE resin.
